(19) United States
(12) Patent Application Publication
(10) Pub. No.: US 2020/0202212 A1
(43) Pub. Date: Jun. 25, 2020

(54) LEARNING DEVICE, LEARNING METHOD, AND COMPUTER-READABLE RECORDING MEDIUM

(71) Applicant: FUJITSU LIMITED, Kawasaki-shi (JP)

(72) Inventor: Shouji Harada, Kawasaki (JP)

(73) Assignee: FUJITSU LIMITED, Kawasaki-shi (JP)

(21) Appl. No.: 16/696,514

(22) Filed: Nov. 26, 2019

(30) Foreign Application Priority Data
Dec. 25, 2018 (JP) 2018-241129

(51) Int. Cl. G06N 3/08; G06N 3/04; G06N 20/20; G06N 20/10

(52) U.S. Cl. CPC G06N 3/08; G06N 20/10; G06N 20/20; G06N 3/0454

(57) ABSTRACT

A learning device includes: a memory; and a processor coupled to the memory and configured to: generate plural first subsets of time-series data by dividing time-series data into predetermined intervals, the time-series data including plural sets of data arranged in time series, and generate first learning data including each of the plural first subsets of time-series data associated with teacher data corresponding to the whole time-series data; learn, based on the first learning data, a first parameter of a first RNN of recurrent neural networks (RNNs), included in plural layers, the first RNN being included in a first layer; and set the learned first parameter for the first RNN, and learn, based on data and the teacher data, parameters of the RNNs included in the plural layers, the data being acquired by input of each of the first subsets of time-series data into the first RNN.

### CROSS-REFERENCE TO RELATED APPLICATION

This application is based upon and claims the benefit of priority of the prior Japanese Patent Application No. 2018-241129, filed on Dec. 25, 2018, the entire contents of which are incorporated herein by reference.

### FIELD

The embodiments discussed herein are related to learning devices and the like.

### BACKGROUND

There is a demand for time-series data to be efficiently and steadily learned in recurrent neural networks (RNNs). In learning in an RNN, a parameter of the RNN is learned such that a value output from the RNN approaches teacher data when learning data, which includes time-series data and the teacher data, is provided to the RNN and the time-series data is input to the RNN.

For example, if the time-series data is a movie review (a word string), the teacher data is data (a correct label) indicating whether the movie review is affirmative or negative. If the time-series data is a sentence (a character string), the teacher data is data indicating what language the sentence is in. The teacher data corresponding to the time-series data corresponds to the whole time-series data, and is not sets of data respectively corresponding to subsets of the time-series data.

FIG. 39 is a diagram illustrating an example of processing by a related RNN. As illustrated in FIG. 39, an RNN 10 is connected to Mean Pooling 1, and when data, for example, a word x, included in time-series data is input to the RNN 10, the RNN 10 finds a hidden state vector h by performing calculation based on a parameter, and outputs the hidden state vector h to Mean Pooling 1. The RNN 10 repeatedly executes this process of finding a hidden state vector h by performing calculation based on the parameter by using next data and the hidden state vector h that has been calculated from the previous data, when the next data is input to the RNN 10.

Described below, for example, is a case where the RNN 10 sequentially acquires words x(0), x(1), x(2), . . . , x(n) that are included in time-series data. When the RNN 10-0 acquires the data x(0), the RNN 10-0 finds a hidden state vector h₀ by performing calculation based on the data x(0) and the parameter, and outputs the hidden state vector h₀ to Mean Pooling 1. When the RNN 10-1 acquires the data x(1), the RNN 10-1 finds a hidden state vector h₁ by performing calculation based on the data x(1), the hidden state vector h₀, and the parameter, and outputs the hidden state vector h₁ to Mean Pooling 1. When the RNN 10-2 acquires the data x(2), the RNN 10-2 finds a hidden state vector h₂ by performing calculation based on the data x(2), the hidden state vector h₁, and the parameter, and outputs the hidden state vector h₂ to Mean Pooling 1. When the RNN 10-n acquires the data x(n), the RNN 10-n finds a hidden state vector hₙ by performing calculation based on the data x(n), the hidden state vector hₙ₋₁, and the parameter, and outputs the hidden state vector hₙ to Mean Pooling 1.

Mean Pooling 1 outputs a vector hₐᵥₑ that is an average of the hidden state vectors h₀ to hₙ. If the time-series data is a movie review, for example, the vector hₐᵥₑ is used in determination of whether the movie review is affirmative or negative.

When learning in the RNN 10 illustrated in FIG. 39 is performed, the longer the length of the time-series data included in learning data is, the longer the calculation time becomes and the lower the efficiency of learning becomes, because calculation corresponding to the time-series is performed in learning of one time, the learning being update of the parameter.

A related technique illustrated in FIG. 40 is one of techniques related to methods of learning in RNNs. FIG. 40 is a diagram illustrating an example of a related method of learning in an RNN. According to this related technique, learning is performed by a short time-series interval being set as an initial learning interval. According to the related technique, the learning interval is gradually extended, and ultimately, learning with the whole time-series data is performed.

For example, according to the related technique, initial learning is performed by use of time series data x(0) and x(1), and when this learning is finished, second learning is performed by use of time-series data x(0), x(1), and x(2). According to the related technique, the learning interval is gradually extended, and ultimately, overall learning is performed by use of time-series data x(0), x(1), x(2), . . . , x(n).

Patent Document 1: Japanese Laid-open Patent Publication No. 08-227410

Patent Document 2: Japanese Laid-open Patent Publication No. 2010-266975

Patent Document 3: Japanese Laid-open Patent Publication No. 05-265994

Patent Document 4: Japanese Laid-open Patent Publication No. 06-231106

### SUMMARY

According to an aspect of an embodiment, a learning device includes: a memory; and a processor coupled to the memory and configured to: generate plural first subsets of time-series data by dividing time-series data into predetermined intervals, the time-series data including plural sets of data arranged in time series, and generate first learning data including each of the plural first subsets of time-series data associated with teacher data corresponding to the whole time-series data; learn, based on the first learning data, a first parameter of a first RNN of recurrent neural networks (RNNs), included in plural layers, the first RNN being included in a first layer; and set the learned first parameter for the first RNN, and learn, based on data and the teacher data, parameters of the RNNs included in the plural layers, the data being acquired by input of each of the first subsets of time-series data into the first RNN, in a case where the parameters of the RNNs included in the plural layers are learned.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a first diagram illustrating processing by a learning device according to a first embodiment;

FIG. 2 is a second diagram illustrating the processing by the learning device according to the first embodiment;

FIG. 3 is a third diagram illustrating the processing by the learning device according to the first embodiment;

FIG. 4 is a functional block diagram illustrating a configuration of the learning device according to the first embodiment;

FIG. 5 is a diagram illustrating an example of a data structure of a learning data table according to the first embodiment;

FIG. 6 is a diagram illustrating an example of a data structure of a first learning data table according to the first embodiment;

FIG. 7 is a diagram illustrating an example of a data structure of a second learning data table according to the first embodiment;

FIG. 8 is a diagram illustrating an example of a hierarchical RNN according to the first embodiment;

FIG. 9 is a diagram illustrating processing by a first generating unit according to the first embodiment;

FIG. 10 is a diagram illustrating processing by a first learning unit according to the first embodiment;

FIG. 11 is a diagram illustrating processing by a second generating unit according to the first embodiment;

FIG. 12 is a diagram illustrating processing by a second learning unit according to the first embodiment;

FIG. 13 is a flow chart illustrating a sequence of the processing by the learning device according to the first embodiment;

FIG. 14 is a diagram illustrating an example of a hierarchical RNN according to a second embodiment;

FIG. 15 is a functional block diagram illustrating a configuration of a learning device according to the second embodiment;

FIG. 16 is a diagram illustrating an example of a data structure of a first learning data table according to the second embodiment;

FIG. 17 is a diagram illustrating an example of a data structure of a second learning data table according to the second embodiment;

FIG. 18 is a diagram illustrating an example of a data structure of a third learning data table according to the second embodiment;

FIG. 19 is a diagram illustrating processing by a first generating unit according to the second embodiment;

FIG. 20 is a diagram illustrating processing by a first learning unit according to the second embodiment;

FIG. 21 is a diagram illustrating an example of a teacher label updating process by the first learning unit according to the second embodiment;

FIG. 22 is a diagram illustrating processing by a second generating unit according to the second embodiment;

FIG. 23 is a diagram illustrating processing by a second learning unit according to the second embodiment;

FIG. 24 is a diagram illustrating processing by a third generating unit according to the second embodiment;

FIG. 25 is a diagram illustrating processing by a third learning unit according to the second embodiment;

FIG. 26 is a flow chart illustrating a sequence of processing by the learning device according to the second embodiment;

FIG. 27 is a diagram illustrating an example of a hierarchical RNN according to a third embodiment;

FIG. 28 is a functional block diagram illustrating a configuration of a learning device according to the third embodiment;

FIG. 29 is a diagram illustrating an example of a data structure of a learning data table according to the third embodiment;

FIG. 30 is a diagram illustrating an example of a data structure of a first learning data table according to the third embodiment;

FIG. 31 is a diagram illustrating an example of a data structure of a second learning data table according to the third embodiment;

FIG. 32 is a diagram illustrating processing by a first generating unit according to the third embodiment;

FIG. 33 is a diagram illustrating processing by a first learning unit according to the third embodiment;

FIG. 34 is a diagram illustrating an example of a teacher label updating process by the first learning unit according to the third embodiment;

FIG. 35 is a diagram illustrating processing by a second generating unit according to the third embodiment;

FIG. 36 is a diagram illustrating processing by a second learning unit according to the third embodiment;

FIG. 37 is a flow chart illustrating a sequence of processing by the learning device according to the third embodiment;

FIG. 38 is a diagram illustrating an example of a hardware configuration of a computer that realizes functions that are the same as those of the learning device according to any one of the first to third embodiments;

FIG. 39 is a diagram illustrating an example of processing by a related RNN; and

FIG. 40 is a diagram illustrating an example of a method of learning in the related RNN.

### DESCRIPTION OF EMBODIMENTS

However, the above described related technique has a problem of not enabling steady learning to be performed efficiently in a short time.

According to the related technique described by reference to FIG. 40, learning is performed by division of the time-series data, but teacher data themselves corresponding to the time-series data corresponds to the whole time-series data. Therefore, it is difficult to appropriately update parameters for RNNs with the related technique. After all, for appropriate parameter learning, learning data, which includes the whole time-series data (x(0), x(1), x(2), . . . , x(n)) and the teacher data, is used according to the related technique, and the learning efficiency is thus not high.

Preferred embodiments of the present invention will be explained with reference to accompanying drawings. This invention is not limited by these embodiments.

### [a] First Embodiment

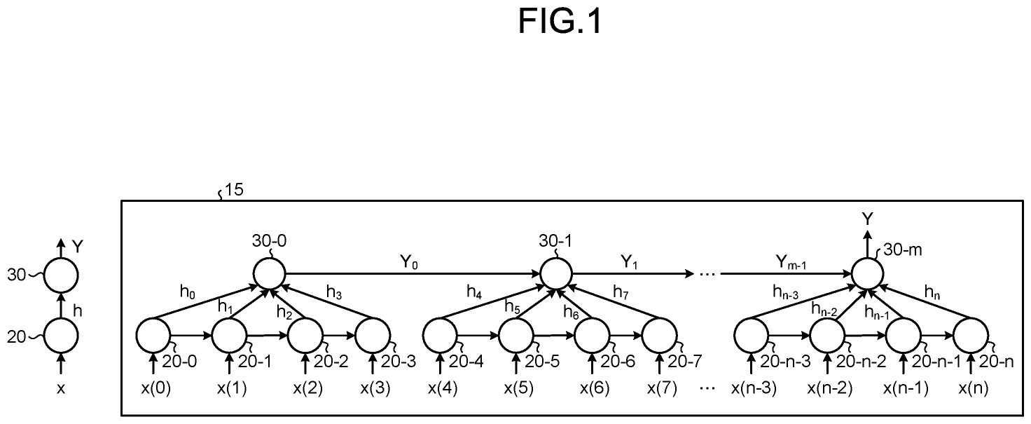

FIG. 1 is a first diagram illustrating processing by a learning device according to a first embodiment. The learning device according to the first embodiment performs learning by using a hierarchical recurrent network 15, which is formed of: a lower-layer RNN 20 that is divided into predetermined units in a time-series direction; and an upper-layer RNN 30 that aggregates these predetermined units in the time-series direction.

Firstly described is an example of processing in a case where time-series data is input to the hierarchical recurrent network 15. When the RNN 20 is connected to the RNN 30 and data (for example, a word x) included in the time-series data is input to the RNN 20, the RNN 20 finds a hidden state vector h by performing calculation based on a parameter θ₂₀ of the RNN 20, and outputs the hidden state vectors h to the RNN 20 and RNN 30. The RNN 20 repeatedly executes the processing of calculating a hidden state vector h by performing calculation based on the parameter θ₂₀ by using next data and the hidden state vector h that has been calculated from the previous data, when the next data is input to the RNN 20.

For example, the RNN 20 according to the first embodiment is an RNN that is in fours in the time-series direction. The time-series data includes data x(0), x(1), x(2), x(3), x(4), . . . , x(n).

When the RNN 20-0 acquires the data x(0), the RNN 20-0 finds a hidden state vector h₀ by performing calculation based on the data x(0) and the parameter θ₂₀, and outputs the hidden state vector h₀ to the RNN 30-0. When the RNN 20-1 acquires the data x(1), the RNN 20-1 finds a hidden state vector h₁ by performing calculation based on the data x(1), the hidden state vector h₀, and the parameter θ₂₀, and outputs the hidden state vector h₁ to the RNN 30-0.

When the RNN 20-2 acquires the data x(2), the RNN 20-2 finds a hidden state vector h₂ by performing calculation based on the data x(2), the hidden state vector h₁, and the parameter θ₂₀, and outputs the hidden state vector h₂ to the RNN 30-0. When the RNN 20-3 acquires the data x(3), the RNN 20-3 finds a hidden state vector h₃ by performing calculation based on the data x(3), the hidden state vector h₂, and the parameter θ₂₀, and outputs the hidden state vector h₃ to the RNN 30-0.

Similarly to the RNN 20-0 to RNN 20-3, when the RNN 20-4 to RNN 20-7 acquire the data x(4) to x(7), the RNN 20-4 to RNN 20-7 each find a hidden state vector h by performing calculation based on the parameter θ₂₀, by using the acquired data and the hidden state vector h that has been calculated from the previous data. The RNN 20-4 to RNN 20-7 output hidden state vectors h₄ to h₇ to the RNN 30-1.

Similarly to the RNN 20-0 to RNN 20-3, when the RNN 20-n-3 to RNN 20-n acquire the data x(n−3) to x(n), the RNN 20-n-3 to RNN 20-n each find a hidden state vector h by performing calculation based on the parameter θ₂₀, by using the acquired data and the hidden state vector h that has been calculated from the previous data. The RNN 20-n-3 to RNN 20-n output hidden state vectors hₙ₋₃ to hₙ to the RNN 30-m.

The RNN 30 aggregates the plural hidden state vectors h₀ to hₙ input from the RNN 20, performs calculation based on a parameter θ₃₀ of the RNN 30, and outputs a hidden state vector Y. For example, when four hidden state vectors h are input from the RNN 20 to the RNN 30, the RNN 30 finds a hidden state vector Y by performing calculation based on the parameter θ₃₀ of the RNN 30. The RNN 30 repeatedly executes the processing of calculating a hidden state vector Y, based on the hidden state vector h that has been calculated immediately before the calculating, four hidden state vectors h, and the parameter θ₃₀, when the four hidden state vectors h are subsequently input to the RNN 30.

By performing calculation based on the hidden state vectors h₀ to h₃ and the parameter θ₃₀, the RNN 30-0 finds a hidden state vector Y₀. By performing calculation based on the hidden state vector Y₀, the hidden state vectors h₄ to h₇, and the parameter θ₃₀, the RNN 30-1 finds a hidden state vector Y₁. The RNN 30-m finds Y by performing calculation based on a hidden state vector Yₘ₋₁ calculated immediately before the calculation, the hidden state vectors hₙ₋₃ to hₙ, and the parameter θ₃₀. This Y is a vector that is a result of estimation for the time-series data.

Described next is processing where the learning device according to the first embodiment performs learning in the recurrent network 15. The learning device performs a second learning process after performing a first learning process. In the first learning process, the learning device learns the parameter θ₂₀ by regarding teacher data to be provided to the lower layer RNN 20-0 to RNN 20-n divided in the time-series direction as the teacher data for the whole time-series data. In the second learning process, the learning device learns the parameter θ₃₀ of the RNN 30-0 to RNN 30-n by using the teacher data for the whole time-series data, without updating the parameter θ₂₀ of the lower layer.

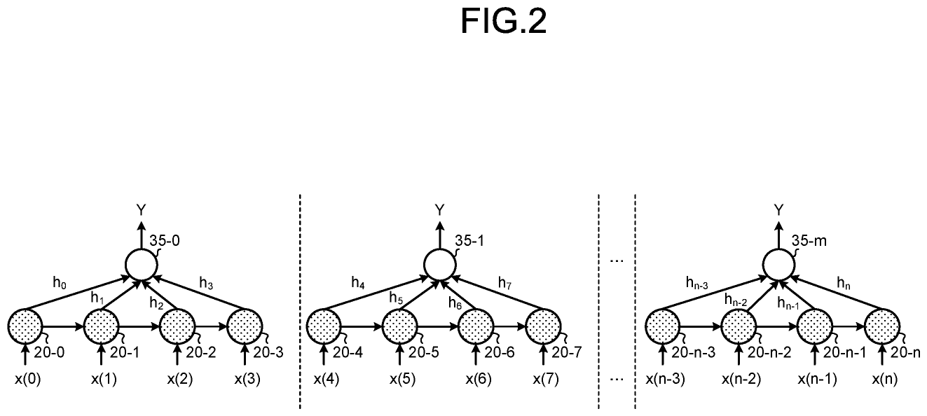

Described below by use of FIG. 2 is the first learning process. Learning data includes the time-series data and the teacher data. The time-series data includes the “data x(0), x(1), x(2), x(3), x(4), . . . , x(n)”. The teacher data is denoted by “Y”.

The learning device inputs the data x(0) to the RNN 20-0, finds the hidden state vector h₀ by performing calculation based on the data x(0) and the parameter θ₂₀, and outputs the hidden state vector h₀ to a node 35-0. The learning device inputs the hidden state vector h₀ and the data x(1), to the RNN 20-1; finds the hidden state vector h₁ by performing calculation based on the hidden state vector h₀, the data x(1), and the parameter θ₂₀; and outputs the hidden state vector h₁ to the node 35-0. The learning device inputs the hidden state vector h₁ and the data x(2), to the RNN 20-2; finds the hidden state vector h₂ by performing calculation based on the hidden state vector h₁, the data x(2), and the parameter θ₂₀; and outputs the hidden state vector h₂ to the node 35-0. The learning device inputs the hidden state vector h₂ and the data x(3), to the RNN 20-3; finds the hidden state vector h₃ by performing calculation based on the hidden state vector h₂, the data x(3), and the parameter θ₂₀; and outputs the hidden state vector h₃ to the node 35-0.

The learning device updates the parameter θ₂₀ of the RNN 20 such that a vector resulting from aggregation of the hidden state vectors h₀ to h₃ input to the node 35-0 approaches the teacher data, “Y”.

Similarly, the learning device inputs the time-series data x(4) to x(7) to the RNN 20-4 to RNN 20-7, and calculates the hidden state vectors h₄ to h₇. The learning device updates the parameter θ₂₀ of the RNN 20 such that a vector resulting from aggregation of the hidden state vectors h₄ to h₇ input to a node 35-1 approaches the teacher data, “Y”.

The learning device inputs the time-series data x(n−3) to x(n) to the RNN 20-n-3 to RNN 20-n, and calculates the hidden state vectors hₙ₋₃ to hₙ. The learning device updates the parameter θ₂₀ of the RNN 20 such that a vector resulting from aggregation of the hidden state vectors hₙ₋₃ to hₙ input to a node 35-m approaches the teacher data, “Y”. The learning device repeatedly executes the above described process by using plural groups of time-series data, “x(0) to x(3)”, “x(4) to x(7)”, . . . , “x(n−3) to x(n)”.

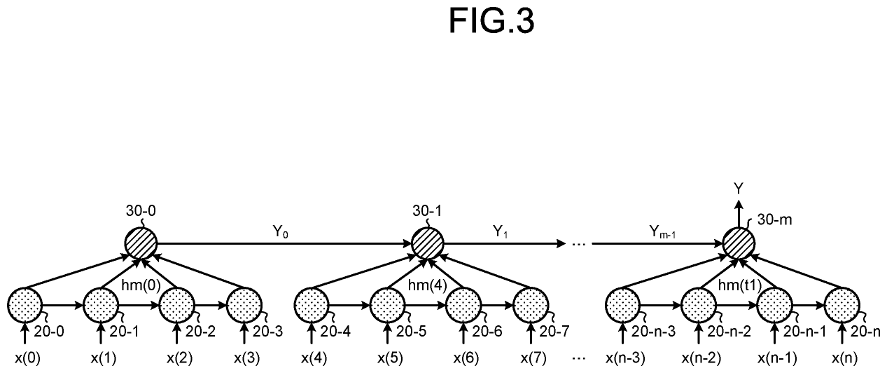

Described by use of FIG. 3 below is the second learning process. When the learning device performs the second learning process, the learning device generates data hm(0), hm(4), . . . , hm(t1) that are time-series data for the second learning process. The data hm(0) is a vector resulting from aggregation of the hidden state vectors h₀ to h₃. The data hm(4) is a vector resulting from aggregation of the hidden state vectors h₄ to h₇. The data hm(t1) is a vector resulting from aggregation of the hidden state vectors hₙ₋₃ to hₙ.

The learning device inputs the data hm (0) to the RNN 30-0, finds the hidden state vector Y₀ by performing calculation based on the data hm(0) and the parameter θ₃₀, and outputs the hidden state vector Y₀ to the RNN 30-1. The learning device inputs the data hm(4) and the hidden state vector Y₀ to the RNN 30-1; finds the hidden state vector Y₁ by performing calculation based on the data hm(0), the hidden state vector Y₀, and the parameter θ₃₀; and outputs the hidden state vector Y₁ to the RNN 30-2 (not illustrated in the drawings) of the next time-series. The learning device finds a hidden state vector Yₘ by performing calculation based on the data hm(t1), the hidden state vector Yₘ₋₁ calculated immediately before the calculation, and the parameter θ₃₀.

The learning device updates the parameter θ₃₀ of the RNN 30 such that the hidden state vector Yₘ output from the RNN 30-m approaches the teacher data, “Y”. By using plural groups of time-series data (hm(0) to hm(t1)), the learning device repeatedly executes the above described process. In the second learning process, update of the parameter θ₂₀ of the RNN 20 is not performed.

As described above, the learning device according to the first embodiment learns the parameter θ₂₀ by regarding the teacher data to be provided to the lower layer RNN 20-0 to RNN 20-n divided in the time-series direction as the teacher data for the whole time-series data. Furthermore, the learning device learns the parameter θ₃₀ of the RNN 30-0 to 30-n by using the teacher data for the whole time-series data, without updating the parameter θ₂₀ of the lower layer. Accordingly, since the parameter θ₂₀ of the lower layer is learned collectively and the parameter θ₃₀ of the upper layer is learned collectively, steady learning is enabled.

Furthermore, since the learning device according to the first embodiment performs learning in predetermined ranges by separation into the upper layer and the lower layer, the learning efficiency is able to be improved. For example, the cost of calculation for the upper layer is able to be reduced to 1/lower-layer-interval-length (for example, the lower-layer-interval-length being 4). For the lower layer, learning (learning for update of the parameter θ₂₀) of “time-series-data-length/lower-layer-interval-length” times the learning achieved by the related technique is enabled with the same number of arithmetic operations as the related technique.

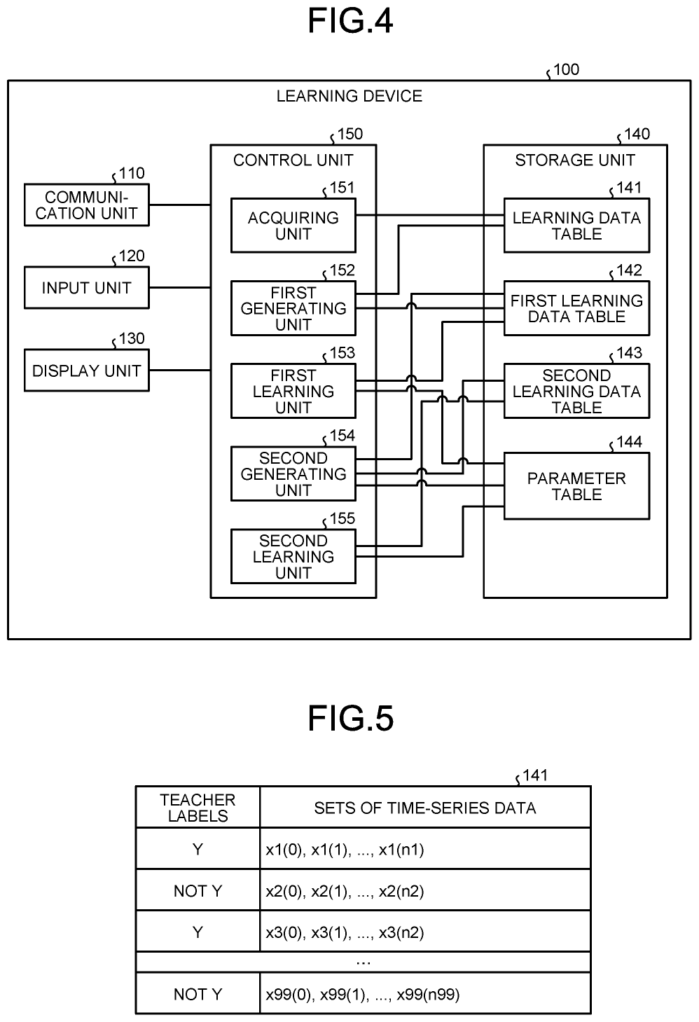

Described next is an example of a configuration of the learning device according to the first embodiment. FIG. 4 is a functional block diagram illustrating the configuration of the learning device according to the first embodiment. As illustrated in FIG. 4, this learning device 100 has a communication unit 110, an input unit 120, a display unit 130, a storage unit 140, and a control unit 150. The learning device 100 according to the first embodiment uses a long short term memory (LSTM), which is an example of RNNs.

The communication unit 110 is a processing unit that executes communication with an external device (not illustrated in the drawings) via a network or the like. For example, the communication unit 110 receives information for a learning data table 141 described later, from the external device. The communication unit 110 is an example of a communication device. The control unit 150, which will be described later, exchanges data with the external device, via the communication unit 110.

The input unit 120 is an input device for input of various types of information, to the learning device 100. For example, the input unit 120 corresponds to a keyboard or a touch panel.

The display unit 130 is a display device that displays thereon various types of information output from the control unit 150. The display unit 130 corresponds to a liquid crystal display, a touch panel, or the like.

The storage unit 140 has the learning data table 141, a first learning data table 142, a second learning data table 143, and a parameter table 144. The storage unit 140 corresponds to: a semiconductor memory device, such as a random access memory (RAM), a read only memory (ROM), or a flash memory; or a storage device, such as a hard disk drive (HDD).

The learning data table 141 is a table storing therein learning data. FIG. 5 is a diagram illustrating an example of a data structure of a learning data table according to the first embodiment. As illustrated in FIG. 5, the learning data table 141 has therein teacher labels associated with sets of time-series data. For example, a teacher label (teacher data) corresponding to a set of time-series data, “x1(0), x1(1), . . . , x1(n)” is “Y”.

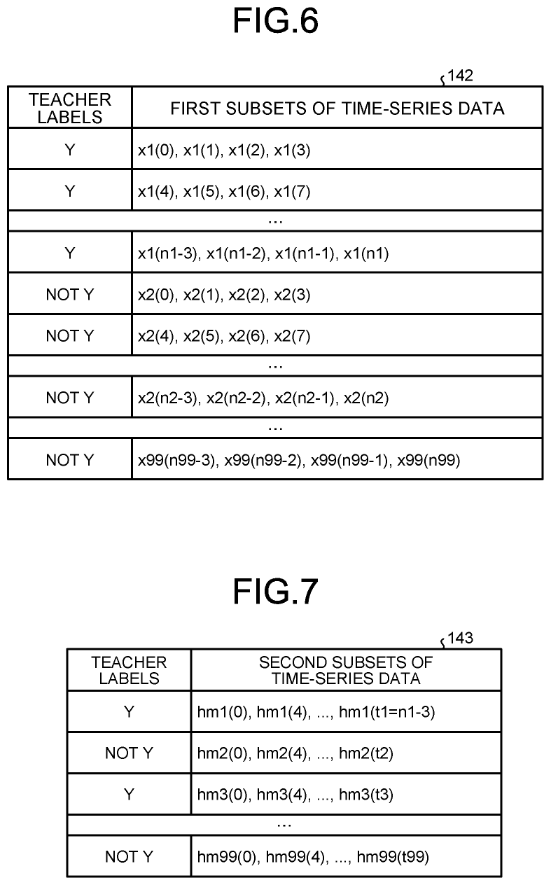

The first learning data table 142 is a table storing therein first subsets of time-series data resulting from division of the time-series data stored in the learning data table 141. FIG. 6 is a diagram illustrating an example of a data structure of a first learning data table according to the first embodiment. As illustrated in FIG. 6, the first learning data table 142 has therein teacher labels associated with the first subsets of time-series data. Each of the first subsets of time-series data is data resulting from division of a set of time-series data into fours. A process of generating the first subsets of time-series data will be described later.

The second learning data table 143 is a table storing therein second subsets of time-series data acquired by input of the first subsets of time-series data of the first learning data table 142 into an LSTM of the lower layer. FIG. 7 is a diagram illustrating an example of a data structure of a second learning data table according to the first embodiment. As illustrated in FIG. 7, the second learning data table 143 has therein teacher labels associated with the second subsets of time-series data. The second subsets of time-series data is acquired by input of the first subsets of time-series data of the first learning data table 142 into the LSTM of the lower layer. A process of generating the second subsets of time-series data will be described later.

The parameter table 144 is a table storing therein a parameter of the LSTM of the lower layer, a parameter of an LSTM of the upper layer, and a parameter of an affine transformation unit.

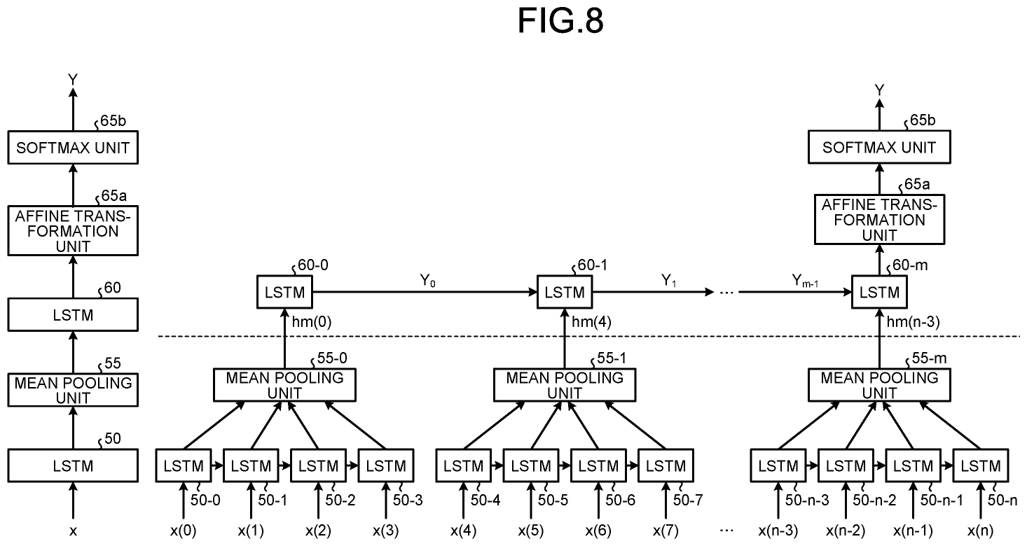

The control unit 150 performs a parameter learning process by executing a hierarchical RNN illustrated in FIG. 8. FIG. 8 is a diagram illustrating an example of a hierarchical RNN according to the first embodiment. As illustrated in FIG. 8, this hierarchical RNN has LSTMs 50 and 60, a mean pooling unit 55, an affine transformation unit 65a, and a softmax unit 65b.

The LSTM 50 is an RNN corresponding to the RNN 20 of the lower layer illustrated in FIG. 1. The LSTM 50 is connected to the mean pooling unit 55. When data included in time-series data is input to the LSTM 50, the LSTM 50 finds a hidden state vector h by performing calculation based on a parameter θ₅₀ of the LSTM 50, and outputs the hidden state vector h to the mean pooling unit 55. The LSTM 50 repeatedly executes the process of calculating a hidden state vector h by performing calculation based on the parameter θ₅₀ by using next data and the hidden state vector h that has been calculated from the previous data, when the next data is input to the LSTM 50.

When the LSTM 50-0 acquires the data x(0), the LSTM 50-0 finds a hidden state vector h₀ by performing calculation based on the data x(0) and the parameter θ₅₀, and outputs the hidden state vector h₀ to the mean pooling unit 55-0. When the LSTM 50-1 acquires the data x(1), the LSTM 50-1 finds a hidden state vector h₁ by performing calculation based on the data x(1), the hidden state vector h₀, and the parameter θ₅₀, and outputs the hidden state vector h₁ to the mean pooling unit 55-0.

When the LSTM 50-2 acquires the data x(2), the LSTM 50-2 finds a hidden state vector h₂ by performing calculation based on the data x(2), the hidden state vector h₁, and the parameter θ₅₀, and outputs the hidden state vector h₂ to the mean pooling unit 55-0. When the LSTM 50-3 acquires the data x(3), the LSTM 50-3 finds a hidden state vector h₃ by performing calculation based on the data x(3), the hidden state vector h₂, and a parameter θ₅₀, and outputs the hidden state vector h₃ to the mean pooling unit 55-0.

Similarly to the LSTM 50-0 to LSTM 50-3, when the LSTM 50-4 to LSTM 50-7 acquire data x(4) to x(7), the LSTM 50-4 to LSTM 50-7 each find a hidden state vector h by performing calculation based on the parameter θ₅₀, by using the acquired data and the hidden state vector h that has been calculated from the previous data. The LSTM 50-4 to LSTM 50-7 output hidden state vectors h₄ to h₇ to the mean pooling unit 55-1.

Similarly to the LSTM 50-0 to LSTM 50-3, when the LSTM 50-n-3 to 50-n acquire the data x(n−3) to x(n), the LSTM 50-n-3 to LSTM 50-n each find a hidden state vector h by performing calculation based on the parameter θ₅₀, by using the acquired data and the hidden state vector h that has been calculated from the previous data. The LSTM 50-n-3 to LSTM 50-n output the hidden state vectors hₙ₋₃ to hₙ to the mean pooling unit 55-m.

The mean pooling unit 55 aggregates the hidden state vectors h input from the LSTM 50 of the lower layer, and outputs an aggregated vector hm to the LSTM 60 of the upper layer. For example, the mean pooling unit 55-0 inputs a vector hm(0) that is an average of the hidden state vectors h₀ to h₃, to the LSTM 60-0. The mean pooling unit 55-1 inputs a vector hm(4) that is an average of the hidden state vectors h₄ to h₇, to the LSTM 60-1. The mean pooling unit 55-m inputs a vector hm(n−3) that is an average of the hidden state vectors hₙ₋₃ to hₙ, to the LSTM 60-m.

The LSTM 60 is an RNN corresponding to the RNN 30 of the upper layer illustrated in FIG. 1. The LSTM 60 outputs a hidden state vector Y by performing calculation based on plural hidden state vectors hm input from the mean pooling unit 55 and a parameter θ₆₀ of the LSTM 60. The LSTM 60 repeatedly executes the process of calculating a hidden state vector Y, based on the hidden state vector Y calculated immediately before the calculating, a subsequent hidden state vector hm, and the parameter θ₆₀, when the hidden state vector hm is input to the LSTM 60 from the mean pooling unit 55.

The LSTM 60-0 finds the hidden state vector Y₀ by performing calculation based on the hidden state vector hm(0) and the parameter θ₆₀. The LSTM 60-1 finds the hidden state vector Y₁ by performing calculation based on the hidden state vector Y₀, the hidden state vector hm(4), and the parameter θ₆₀. The LSTM 60-m finds the hidden state vector Yₘ by performing calculation based on the hidden state vector Yₘ₋₁ calculated immediately before the calculation, the hidden state vector hm(n−3), and the parameter θ₆₀. The LSTM 60-m outputs the hidden state vector Yₘ to the affine transformation unit 65a.

The affine transformation unit 65a is a processing unit that executes affine transformation on the hidden state vector Yₘ output from the LSTM 60. For example, the affine transformation unit 65a calculates a vector Y_{A} by executing affine transformation based on Equation (1). In Equation (1), “A” is a matrix, and “b” is a vector. Learned weights are set for elements of the matrix A and elements of the vector b.

Y_{A}=AYm+b (1)

The softmax unit 65b is a processing unit that calculates a value, “Y”, by inputting the vector Y_{A} resulting from the affine transformation, into a softmax function. This value, “Y”, is a vector that is a result of estimation for the time-series data.

Description will now be made by reference to FIG. 4 again. The control unit 150 has an acquiring unit 151, a first generating unit 152, a first learning unit 153, a second generating unit 154, and a second learning unit 155. The control unit 150 may be realized by a central processing unit (CPU), a micro processing unit (MPU), or the like. Furthermore, the control unit 150 may be realized by hard wired logic, such as an application specific integrated circuit (ASIC) or a field programmable gate array (FPGA). The second generating unit 154 and the second learning unit 155 are an example of a learning processing unit.

The acquiring unit 151 is a processing unit that acquires information for the learning data table 141 from an external device (not illustrated in the drawings) via a network. The acquiring unit 151 stores the acquired information for the learning data table 141, into the learning data table 141.

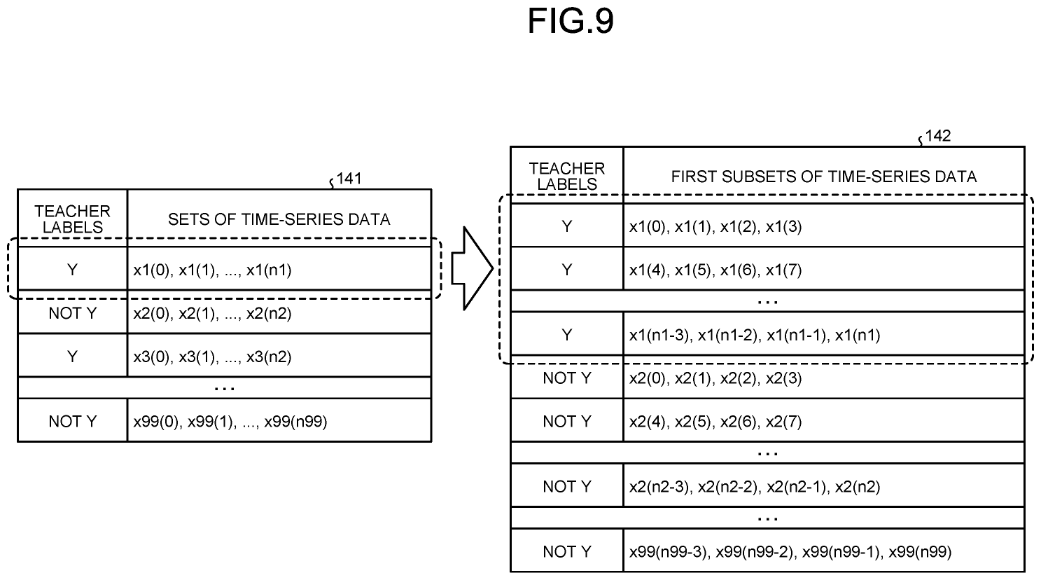

The first generating unit 152 is a processing unit that generates information for the first learning data table 142, based on the learning data table 141. FIG. 9 is a diagram illustrating processing by a first generating unit according to the first embodiment. The first generating unit 152 selects a record in the learning data table 141, and divides time-series data in the selected record in fours that are predetermined intervals. The first generating unit 152 stores each of the divided groups (the first subsets of time-series data) in association with a teacher label corresponding to the pre-division time-series data, into the first learning data table 142, each of the divided groups having four pieces of data.

For example, the first generating unit 152 divides the set of time-series data, “x1(0), x1(1), . . . , x(n1)”, into first subsets of time-series data, “x1(0), x1(1), x1(2), and x1(3)”, “x1(4), x1(5), x1(6), and x1(7)”, . . . , “x1(n1-3), x1(n1-2), x1(n1-1), and x1(n1)”. The first generating unit 152 stores each of the first subsets of time-series data in association with the teacher label, “Y”, corresponding to the pre-division set of time-series data, “x1(0), x1(1), . . . , x(n1)”, into the first learning data table 142.

The first generating unit 152 generates information for the first learning data table 142 by repeatedly executing the above described processing, for the other records in the learning data table 141. The first generating unit 152 stores the information for the first learning data table 142, into the first learning data table 142.

The first learning unit 153 is a processing unit that learns the parameter θ₅₀ of the LSTM 50 of the hierarchical RNN, based on the first learning data table 142. The first learning unit 153 stores the learned parameter θ₅₀ into the parameter table 144. Processing by the first learning unit 153 corresponds to the above described first learning process.

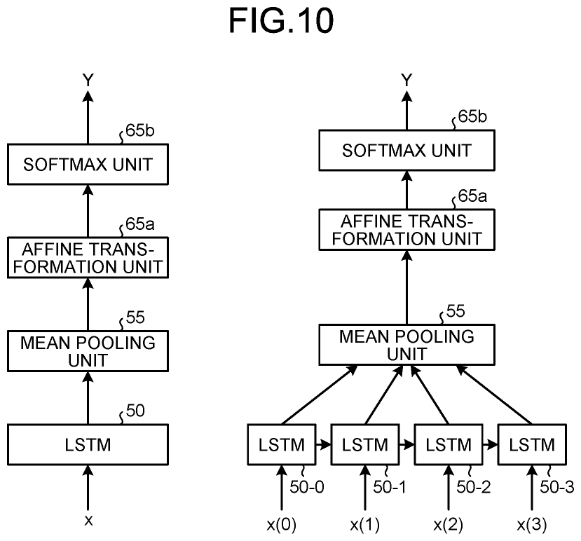

FIG. 10 is a diagram illustrating processing by a first learning unit according to the first embodiment. The first learning unit 153 executes the LSTM 50, the mean pooling unit 55, the affine transformation unit 65a, and the softmax unit 65b. The first learning unit 153 connects the LSTM 50 to the mean pooling unit 55, connects the mean pooling unit 55 to the affine transformation unit 65a, and connects the affine transformation unit 65a to the softmax unit 65b. The first learning unit 153 sets the parameter θ₅₀ of the LSTM 50 to an initial value.

The first learning unit 153 inputs the first subsets of time-series data in the first learning data table 142 sequentially into the LSTM 50-0 to LSTM 50-3, and learns the parameter θ₅₀ of the LSTM 50 and the parameter of the affine transformation unit 65a, such that a deduced label output from the softmax unit 65b approaches the teacher label. The first learning unit 153 repeatedly executes the above described processing for the first subsets of time-series data stored in the first learning data table 142. For example, the first learning unit 153 learns the parameter θ₅₀ of the LSTM 50 and the parameter of the affine transformation unit 65a, by using the gradient descent method or the like.

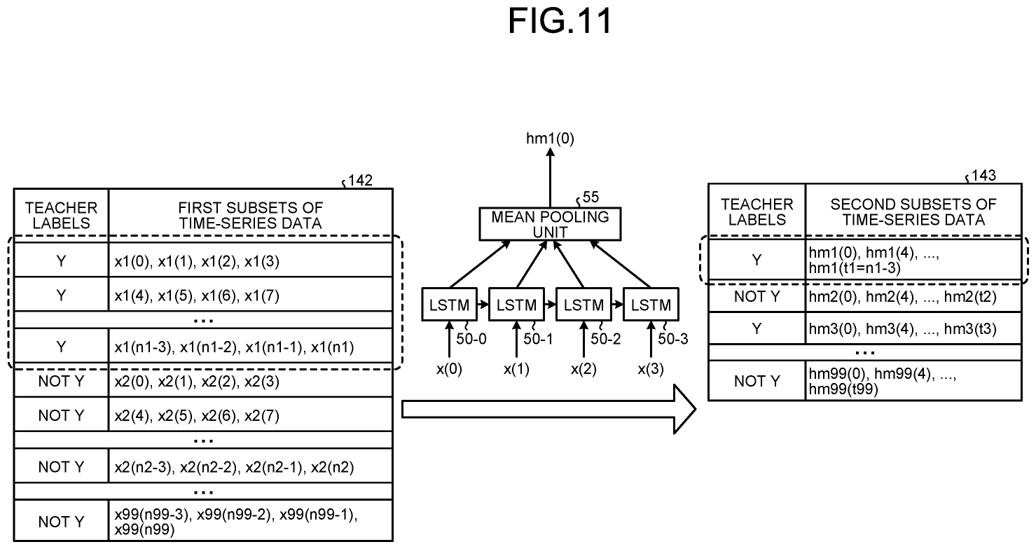

The second generating unit 154 is a processing unit that generates information for the second learning data table 143, based on the first learning data table 142. FIG. 11 is a diagram illustrating processing by a second generating unit according to the first embodiment.

The second generating unit 154 executes the LSTM 50 and the mean pooling unit 55, and sets the parameter θ₅₀ that has been learned by the first learning unit 153, for the LSTM 50. The second generating unit 154 repeatedly executes a process of calculating data hm output from the mean pooling unit 55 by sequentially inputting the first subsets of time-series data into the LSTM 50-1 to LSTM 50-3. The second generating unit 154 calculates a second subset of time-series data by inputting first subsets of time-series data resulting from division of time-series data of one record from the learning data table 141, into the LSTM 50. A teacher label corresponding to that second subset of time-series data is the teacher label corresponding to the pre-division time-series data.

For example, by inputting each of the first subsets of time-series data, “x1(0), x1(1), x1(2), and x1(3)”, “x1(4), x1(5), x1(6), and x1(7)”, . . . , “x1(n1-3), x1(n1-2), x1(n1-1), and x1(n1)”, into the LSTM 50, the second generating unit 154 calculates a second subset of time-series data, “hm1(0), hm1(4), . . . , hm1(t1)”. A teacher label corresponding to that second subset of time-series data, “hm1(0), hm1(4), . . . , hm1(t1)” is the teacher label, “Y”, of the time-series data, “x1(0), x1(1), . . . , x(n1)”.

The second generating unit 154 generates information for the second learning data table 143 by repeatedly executing the above described processing, for the other records in the first learning data table 142. The second generating unit 154 stores the information for the second learning data table 143, into the second learning data table 143.

The second learning unit 155 is a processing unit that learns the parameter θ₆₀ of the LSTM 60 of the hierarchical RNN, based on the second learning data table 143. The second learning unit 155 stores the learned parameter θ₆₀ into the parameter table 144. Processing by the second learning unit 155 corresponds to the above described second learning process. Furthermore, the second learning unit 155 stores the parameter of the affine transformation unit 65a, into the parameter table 144.

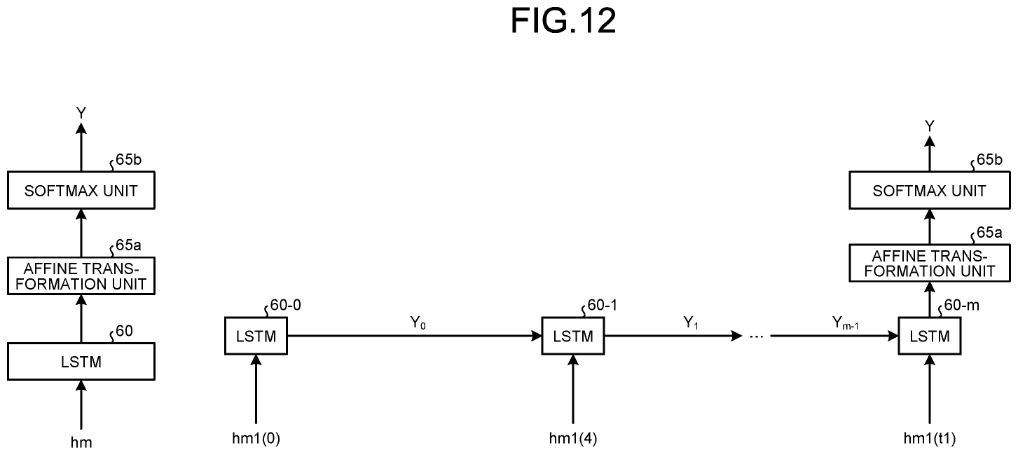

FIG. 12 is a diagram illustrating processing by a second learning unit according to the first embodiment. The second learning unit 155 executes the LSTM 60, the affine transformation unit 65a, and the softmax unit 65b. The second learning unit 155 connects the LSTM 60 to the affine transformation unit 65a, and connects the affine transformation unit 65a to the softmax unit 65b. The second learning unit 155 sets the parameter θ₆₀ of the LSTM 60 to an initial value.

The second learning unit 155 sequentially inputs the second subsets of time-series data stored in the second learning data table 143, into the LSTM 60-0 to LSTM 60-m, and learns the parameter θ₆₀ of the LSTM 60 and the parameter of the affine transformation unit 65a, such that a deduced label output from the softmax unit 65b approaches the teacher label. The second learning unit 155 repeatedly executes the above described processing for the second subsets of time-series data stored in the second learning data table 143. For example, the second learning unit 155 learns the parameter θ₆₀ of the LSTM 60 and the parameter of the affine transformation unit 65a, by using the gradient descent method or the like.

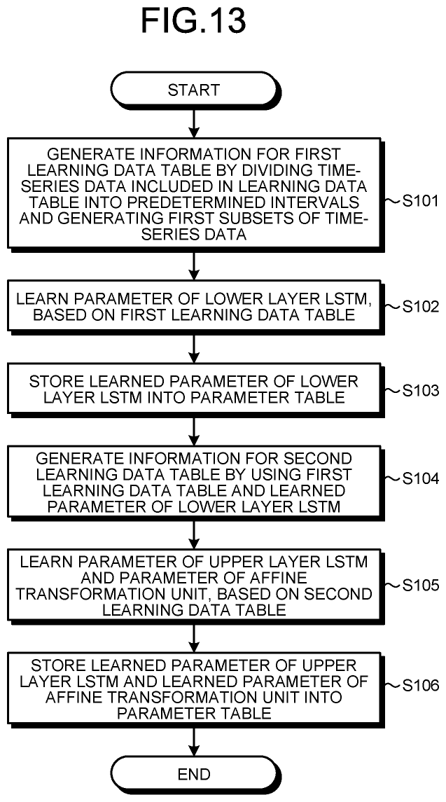

Described next is an example of a sequence of processing by the learning device 100 according to the first embodiment. FIG. 13 is a flow chart illustrating a sequence of processing by the learning device according to the first embodiment. As illustrated in FIG. 13, the first generating unit 152 of the learning device 100 generates first subsets of time-series data by dividing time-series data included in the learning data table 141 into predetermined intervals, and thereby generates information for the first learning data table 142 (Step S101).

The first learning unit 153 of the learning device 100 learns the parameter θ₆₀ of the LSTM 50 of the lower layer, based on the first learning data table 142 (Step S102). The first learning unit 153 stores the learned parameter θ₅₀ of the LSTM 50 of the lower layer, into the parameter table 144 (Step S103).

The second generating unit 154 of the learning device 100 generates information for the second learning data table 143 by using the first learning data table and the learned parameter θ₅₀ of the LSTM 50 of the lower layer (Step S104).

Based on the second learning data table 143, the second learning unit 155 of the learning device 100 learns the parameter θ₆₀ of the LSTM 60 of the upper layer and the parameter of the affine transformation unit 65a (Step S105). The second learning unit 155 stores the learned parameter θ₆₀ of the LSTM 60 of the upper layer and the learned parameter of the affine transformation unit 65a, into the parameter table 144 (Step S106). The information in the parameter table 144 may be reported to an external device, or may be output to and displayed on a terminal of an administrator.

Described next are effects of the learning device 100 according to the first embodiment. The learning device 100 learns the parameter θ₅₀ by: generating first subsets of time-series data resulting from division of time-series data into predetermined intervals; and regarding teacher data to be provided to the lower layer LSTM 50-0 to LSTM 50-n divided in the time-series direction as teacher data of the whole time-series data. Furthermore, without updating the learned parameter θ₅₀, the learning device 100 learns the parameter θ₆₀ of the upper layer LSTM 60-0 to LSTM 60-m by using the teacher data of the whole time-series data. Accordingly, since the parameter θ₅₀ of the lower layer is learned collectively and the parameter θ₆₀ of the upper layer is learned collectively, steady learning is enabled.

Furthermore, since the learning device 100 according to the first embodiment performs learning in predetermined ranges by separation into the upper layer and the lower layer, the learning efficiency is able to be improved. For example, the cost of calculation for the upper layer is able to be reduced to 1/lower-layer-interval-length (for example, the lower-layer-interval-length being 4). For the lower layer, learning of “time-series-data-length/lower-layer-interval-length” times the learning achieved by the related technique is enabled with the same number of arithmetic operations as the related technique.

### [b] Second Embodiment

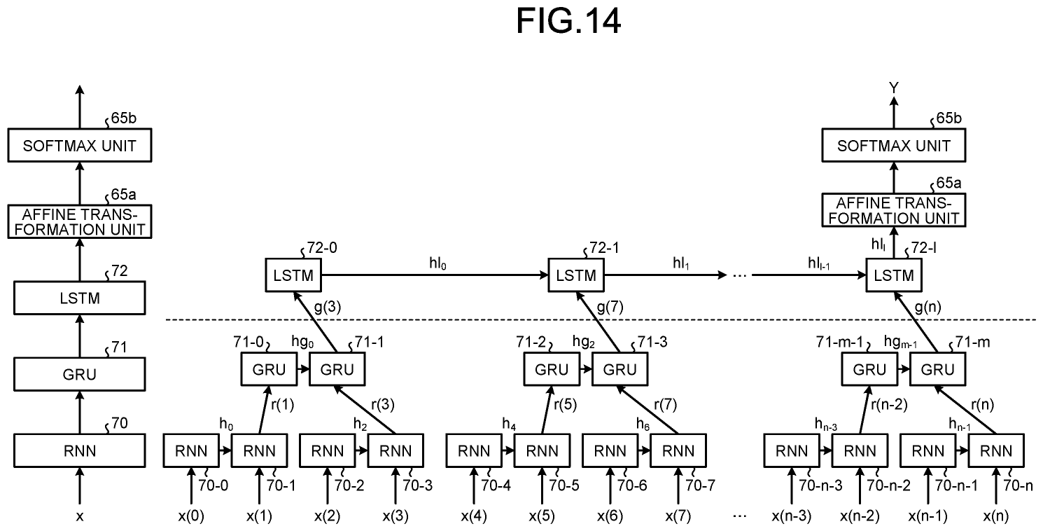

FIG. 14 is a diagram illustrating an example of a hierarchical RNN according to a second embodiment. As illustrated in FIG. 14, this hierarchical RNN has an RNN 70, a gated recurrent unit (GRU) 71, an LSTM 72, an affine transformation unit 75a, and a softmax unit 75b. In FIG. 14, the GRU 71 and the RNN 70 are used as a lower layer RNN for example, but another RNN may be connected further to the lower layer RNN.

When the RNN 70 is connected to the GRU 71, and data (for example, a word x) included in time-series data is input to the RNN 70, the RNN 70 finds a hidden state vector h by performing calculation based on a parameter θ₇₀ of the RNN 70, and inputs the hidden state vector h to the RNN 70. When the next data is input to the RNN 70, the RNN 70 finds a hidden state vector r by performing calculation based on the parameter θ₇₀ by using the next data and the hidden state vector h that has been calculated from the previous data, and inputs the hidden state vector r to the GRU 71. The RNN 70 repeatedly executes the process of inputting the hidden state vector r calculated upon input of two pieces of data into the GRU 71.

For example, the time-series data input to the RNN 70 according to the first embodiment includes data x(0), x(1), x(2), x(3), x(4), . . . , x(n).

When the RNN 70-0 acquires the data x(0), the RNN 70-0 finds a hidden state vector h₀ by performing calculation based on the data x(0) and the parameter θ₇₀, and outputs the hidden state vector h₀ to the RNN 70-1. When the RNN 70-1 acquires the data x(1), the RNN 70-1 finds a hidden state vector r(1) by performing calculation based on the data x(1), the hidden state vector h₀, and the parameter θ₇₀, and outputs the hidden state vector r(1) to the GRU 71-0.

When the RNN 70-2 acquires the data x(2), the RNN 70-2 finds a hidden state vector h₂ by performing calculation based on the data x(2) and the parameter θ₇₀, and outputs the hidden state vector h₂ to the RNN 70-3. When the RNN 70-3 acquires the data x(3), the RNN 70-3 finds a hidden state vector r(3) by performing calculation based on the data x(3), the hidden state vector h₂, and the parameter θ₇₀, and outputs the hidden state vector r(3) to the GRU 71-1.

Similarly to the RNN 70-0 and RNN 70-1, when the data x(4) and x(5) are input to the RNN 70-4 and RNN 70-5, the RNN 70-4 and RNN 70-5 find hidden state vectors h₄ and r(5) by performing calculation based on the parameter θ₇₀, and output the hidden state vector r(5) to the GRU 71-2.

Similarly to the RNN 70-2 and RNN 70-3, when the data x(6) and x(7) are input to the RNN 70-6 and RNN 70-7, the RNN 70-6 and RNN 70-7 find hidden state vectors h₆ and r(7) by performing calculation based on the parameter θ₇₀, and output the hidden state vector r(7) to the GRU 71-3.

Similarly to the RNN 70-0 and RNN 70-1, when the data x(n−3) and x(n−2) are input to the RNN 70-n-3 and RNN 70-n-2, the RNN 70-n-3 and RNN 70-n-2 find hidden state vectors hₙ₋₃ and r(n−2) by performing calculation based on the parameter θ₇₀, and output the hidden state vector r(n−2) to the GRU 71-m-1.

Similarly to the RNN 70-2 and RNN 70-3, when the data x(n−1) and x(n) are input to the RNN 70-n-1 and RNN 70-n, the RNN 70-n-1 and RNN 70-n find hidden state vectors hₙ₋₁ and r(n) by performing calculation based on the parameter θ₇₀, and output the hidden state vector r(n) to the GRU 71-m.

The GRU 71 finds a hidden state vector hg by performing calculation based on a parameter θ₇₁ of the GRU 71 for each of plural hidden state vectors r input from the RNN 70, and inputs the hidden state vector hg to the GRU 71. When the next hidden state vector r is input to the GRU 71, the GRU 71 finds a hidden state vector g by performing calculation based on the parameter θ₇₁ by using the hidden state vector hg and the next hidden state vector r. The GRU 71 outputs the hidden state vector g to the LSTM 72. The GRU 71 repeatedly executes the process of inputting, to the LSTM 72, the hidden state vector g calculated upon input of two hidden state vectors r to the GRU 71.

When the GRU 71-0 acquires the hidden state vector r(1), the GRU 71-0 finds a hidden state vector hg₀ by performing calculation based on the hidden state vector r(1) and the parameter θ₇₁, and outputs the hidden state vector hg₀ to the GRU 71-1. When the GRU 71-1 acquires the hidden state vector r(3), the GRU 71-1 finds a hidden state vector g(1) by performing calculation based on the hidden state vector r(3), the hidden state vector hg₀, and the parameter θ₇₁, and outputs the hidden state vector g(1) to the LSTM 72-0.

Similarly to the GRU 71-0 and GRU 71-1, when the hidden state vectors r(5) and r(7) are input to the GRU 71-2 and GRU 71-3, the GRU 71-2 and GRU 71-3 find hidden state vectors hg₂ and g(7) by performing calculation based on the parameter θ₇₁, and output the hidden state vector g(7) to the LSTM 72-1.

Similarly to the GRU 71-0 and GRU 71-1, when the hidden state vectors r(n−2) and r(n) are input to the GRU 71-m-1 and GRU 71-m, the GRU 71-m-1 and GRU 71-m find hidden state vectors hgₘ₋₁ and g(n) by performing calculation based on the parameter θ₇₁, and outputs the hidden state vector g(n) to the LSTM 72-1.

When a hidden state vector g is input from the GRU 71, the LSTM 72 finds a hidden state vector hl by performing calculation based on the hidden state vector g and a parameter θ₇₂ of the LSTM 72. When the next hidden state vector g is input to the LSTM 72, the LSTM 72 finds a hidden state vector hl by performing calculation based on the hidden state vectors hl and g and the parameter θ₇₂. Every time a hidden state vector g is input to the LSTM 72, the LSTM 72 repeatedly executes the above described processing. The LSTM 72 then outputs a hidden state vector hl to the affine transformation unit 65a.

When the hidden state vector g(3) is input to the LSTM 72-0 from the GRU 71-1, the LSTM 72-0 finds a hidden state vector hl₀ by performing calculation based on the hidden state vector g(3) and the parameter θ₇₂ of the LSTM 72. The LSTM 72-0 outputs the hidden state vector hl₀ to the LSTM 72-1.

When the hidden state vector g(7) is input to the LSTM 72-1 from the GRU 71-3, the LSTM 72-1 finds a hidden state vector hl₁ by performing calculation based on the hidden state vector g(7) and the parameter θ₇₂ of the LSTM 72. The LSTM 72-1 outputs the hidden state vector hl₁ to the LSTM 72-2 (not illustrated in the drawings).

When the hidden state vector g(n) is input to the LSTM 72-1 from the GRU 71-m, the LSTM 72-1 finds a hidden state vector hl₁ by performing calculation based on the hidden state vector g(n) and the parameter θ₇₂ of the LSTM 72. The LSTM 72-1 outputs the hidden state vector hl₁ to the affine transformation unit 75a.

The affine transformation unit 75a is a processing unit that executes affine transformation on the hidden state vector hl₁ output from the LSTM 72. For example, the affine transformation unit 75a calculates a vector Y_{A} by executing affine transformation based on Equation (2). Description related to “A” and “b” included in Equation (2) is the same as the description related to “A” and “b” included in Equation (1).

Y_{A}=Ahl₁+b (2)

The softmax unit 75b is a processing unit that calculates a value, “Y”, by inputting the vector Y_{A} resulting from the affine transformation, into a softmax function. This value, “Y”, is a vector that is a result of estimation for the time-series data.

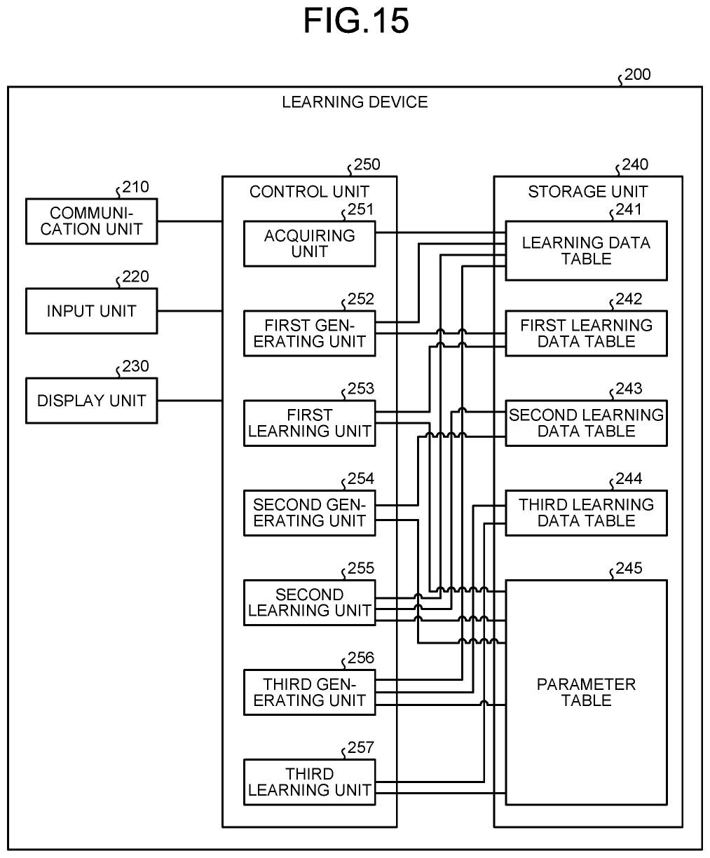

Described next is an example of a configuration of a learning device according to the second embodiment. FIG. 15 is a functional block diagram illustrating the configuration of the learning device according to the second embodiment. As illustrated in FIG. 15, this learning device 200 has a communication unit 210, an input unit 220, a display unit 230, a storage unit 240, and a control unit 250.

The communication unit 210 is a processing unit that executes communication with an external device (not illustrated in the drawings) via a network or the like. For example, the communication unit 210 receives information for a learning data table 241 described later, from the external device. The communication unit 210 is an example of a communication device. The control unit 250 described later exchanges data with the external device via the communication unit 210.

The input unit 220 is an input device for input of various types of information into the learning device 200. For example, the input unit 220 corresponds to a keyboard, or a touch panel.

The display unit 230 is a display device that displays thereon various types of information output from the control unit 250. The display unit 230 corresponds to a liquid crystal display, a touch panel, or the like.

The storage unit 240 has the learning data table 241, a first learning data table 242, a second learning data table 243, a third learning data table 244, and a parameter table 245. The storage unit 240 corresponds to: a semiconductor memory device, such as a RAM, a ROM, or a flash memory; or a storage device, such as an HDD.

The learning data table 241 is a table storing therein learning data. Since the learning data table 241 has a data structure similar to the data structure of the learning data table 141 illustrated in FIG. 5, description thereof will be omitted.

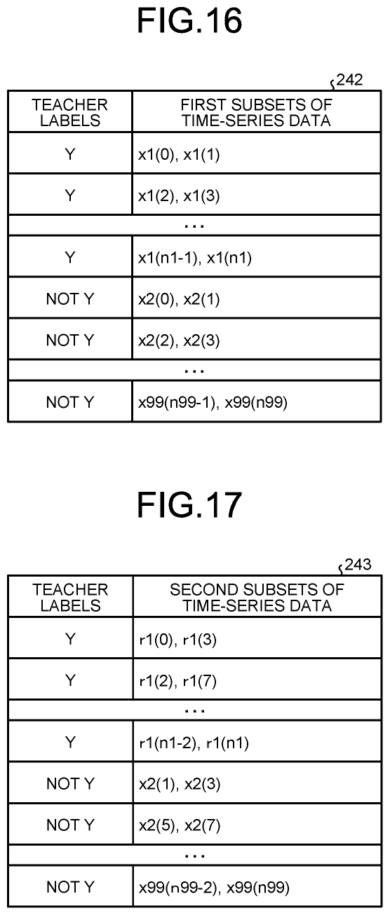

The first learning data table 242 is a table storing therein first subsets of time-series data resulting from division of time-series data stored in the learning data table 241. FIG. 16 is a diagram illustrating an example of a data structure of a first learning data table according to the second embodiment. As illustrated in FIG. 16, the first learning data table 242 has therein teacher labels associated with the first subsets of time-series data. Each of the first subsets of time-series data according to the second embodiment is data resulting from division of a set of time-series data into twos. A process of generating the first subsets of time-series data will be described later.

The second learning data table 243 is a table storing therein second subsets of time-series data acquired by input of the first subsets of time-series data in the first learning data table 242 into the RNN 70 of the lower layer. FIG. 17 is a diagram illustrating an example of a data structure of a second learning data table according to the second embodiment. As illustrated in FIG. 17, the second learning data table 243 has therein teacher labels associated with the second subsets of time-series data. A process of generating the second subsets of time-series data will be described later.

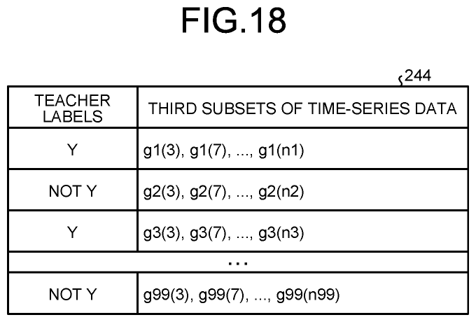

The third learning data table 244 is a table storing therein third subsets of time-series data output from the GRU 71 of the upper layer when the time-series data of the learning data table 241 is input to the RNN 70 of the lower layer. FIG. 18 is a diagram illustrating an example of a data structure of a third learning data table according to the second embodiment. As illustrated in FIG. 18, the third learning data table 244 has therein teacher labels associated with the third subsets of time-series data. A process of generating the third subsets of time-series data will be described later.

The parameter table 245 is a table storing therein the parameter θ₇₀ of the RNN 70 of the lower layer, the parameter θ₇₁ of the GRU 71, the parameter θ₇₂ of the LSTM 72 of the upper layer, and the parameter of the affine transformation unit 75a.

The control unit 250 is a processing unit that learns a parameter by executing the hierarchical RNN described by reference to FIG. 14. The control unit 250 has an acquiring unit 251, a first generating unit 252, a first learning unit 253, a second generating unit 254, a second learning unit 255, a third generating unit 256, and a third learning unit 257. The control unit 250 may be realized by a CPU, an MPU, or the like. Furthermore, the control unit 250 may be realized by hard wired logic, such as an ASIC or an FPGA.

The acquiring unit 251 is a processing unit that acquires information for the learning data table 241, from an external device (not illustrated in the drawings) via a network. The acquiring unit 251 stores the acquired information for the learning data table 241, into the learning data table 241.

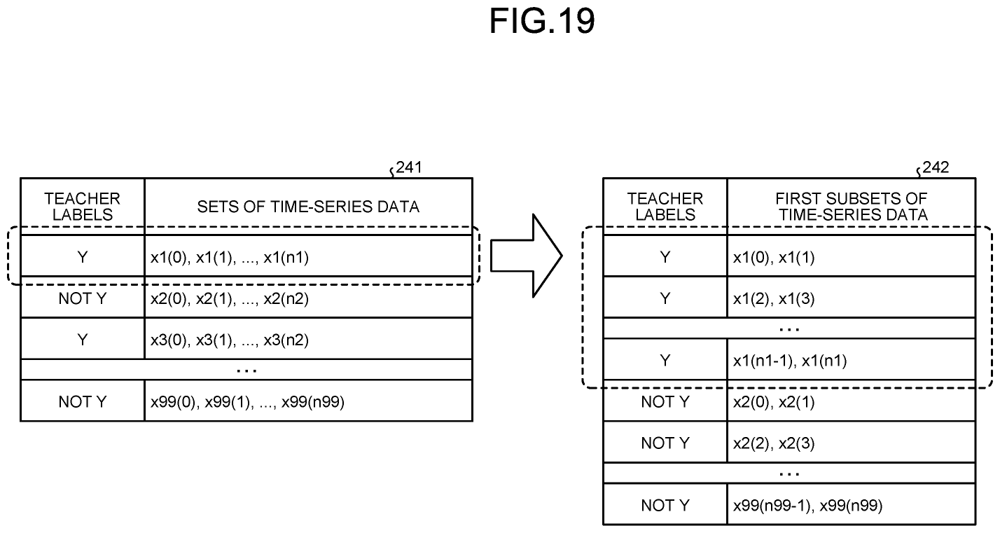

The first generating unit 252 is a processing unit that generates, based on the learning data table 241, information for the first learning data table 242. FIG. 19 is a diagram illustrating processing by a first generating unit according to the second embodiment. The first generating unit 252 selects a record in the learning data table 241, and divides a set of time-series data of the selected record in twos that are predetermined intervals. The first generating unit 252 stores divided pairs of pieces of data (first subsets of time-series data) respectively in association with teacher labels corresponding to the pre-division set of time-series data, into the first learning data table 242.

For example, the first generating unit 252 divides a set of time-series data “x1(0), x1(1), . . . , x(n1)” into first subsets of time-series data, “x1(0) and x1(1)”, “x1(2) and x1(3)”, . . . , “x1(n1-1) and x1(n1)”. The first generating unit 252 stores these first subsets of time-series data in association with a teacher label, “Y”, corresponding to the pre-division set of time-series data, “x1(0), x1(1), . . . , x(n1)”, into the first learning data table 242.

The first generating unit 252 generates information for the first learning data table 242 by repeatedly executing the above described processing, for the other records in the learning data table 241. The first generating unit 252 stores the information for the first learning data table 242, into the first learning data table 242.

The first learning unit 253 is a processing unit that learns the parameter θ₇₀ of the RNN 70, based on the first learning data table 242. The first learning unit 253 stores the learned parameter θ₇₀ into the parameter table 245.

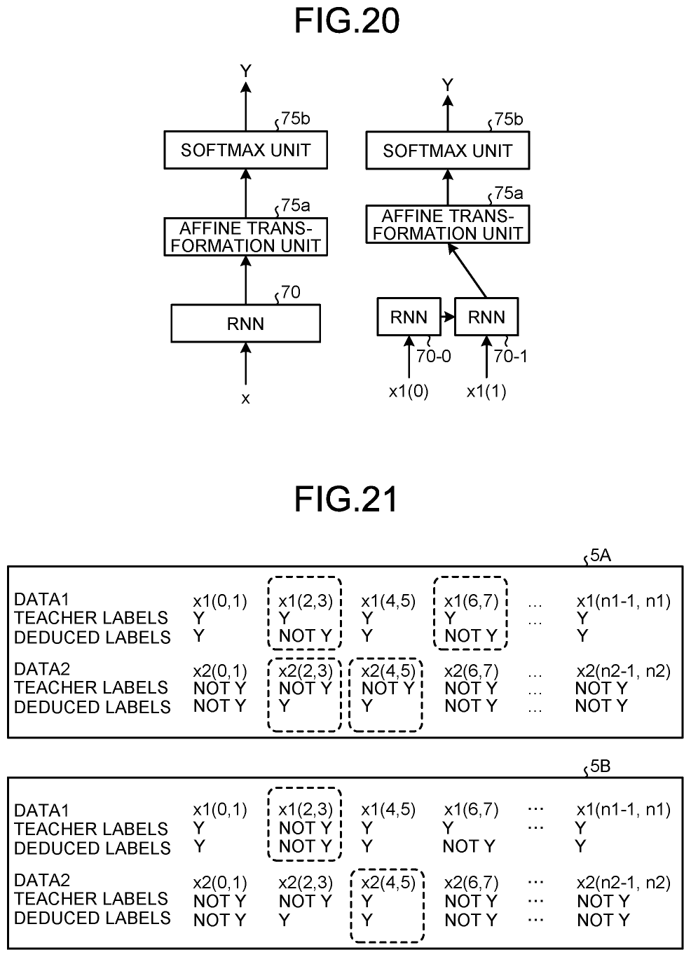

FIG. 20 is a diagram illustrating processing by a first learning unit according to the second embodiment. The first learning unit 253 executes the RNN 70, the affine transformation unit 75a, and the softmax unit 75b. The first learning unit 253 connects the RNN 70 to the affine transformation unit 75a, and connects the affine transformation unit 75a to the softmax unit 75b. The first learning unit 253 sets the parameter θ₇₀ of the RNN 70 to an initial value.

The first learning unit 253 sequentially inputs the first subsets of time-series data stored in the first learning data table 242 into the RNN 70-0 to RNN 70-1, and learns the parameter θ₇₀ of the RNN 70 and a parameter of the affine transformation unit 75a, such that a deduced label Y output from the softmax unit 75b approaches the teacher label. The first learning unit 253 repeatedly executes the above described processing “D” times for the first subsets of time-series data stored in the first learning data table 242. This “D” is a value that is set beforehand, and for example, “D=10”. The first learning unit 253 learns the parameter θ₇₀ of the RNN 70 and the parameter of the affine transformation unit 75a, by using the gradient descent method or the like.

When the first learning unit 253 has performed the learning D times, the first learning unit 253 executes a process of updating the teacher labels in the first learning data table 242. FIG. 21 is a diagram illustrating an example of a teacher label updating process by the first learning unit according to the second embodiment.

A learning result 5A in FIG. 21 has therein first subsets of time-series data (data 1, data 2, and so on), teacher labels, and deduced labels, in association with one another. For example, “x1(0,1)” indicates that the data x1(0) and x(1) have been input to the RNN 70-0 and RNN 70-1. The teacher labels are teacher labels defined in the first learning data table 242 and corresponding to the first subsets of time-series data. The deduced labels are deduced labels output from the softmax unit 75b when the first subsets of time-series data are input to the RNN 70-0 and RNN 70-1 in FIG. 20. The learning result 5A indicates that the teacher label for x1(0,1) is “Y” and the deduced label therefor is “Y”.

In the example represented by the learning result 5A, the teacher label differs from the deduced label for each of x1(2,3), x1(6,7), x2(2,3), and x2(4,5). The first learning unit 253 updates a predetermined proportion of the teacher labels, each for which the deduced label differs from the teacher label, to the deduced label/labels. As indicated by an update result 5B, the first learning unit 253 updates the teacher label corresponding to x1(2,3) to “Not Y”, and updates the teacher label corresponding to x2(4,5) to “Y”. The first learning unit 253 causes the update described by reference to FIG. 21 to be reflected in the teacher labels in the first learning data table 242.

By using the updated first learning data table 242, the first learning unit 253 learns the parameter θ₇₀ of the RNN 70, and the parameter of the affine transformation unit 75a, again. The first learning unit 253 stores the learned parameter θ₇₀ of the RNN 70 into the parameter table 245.

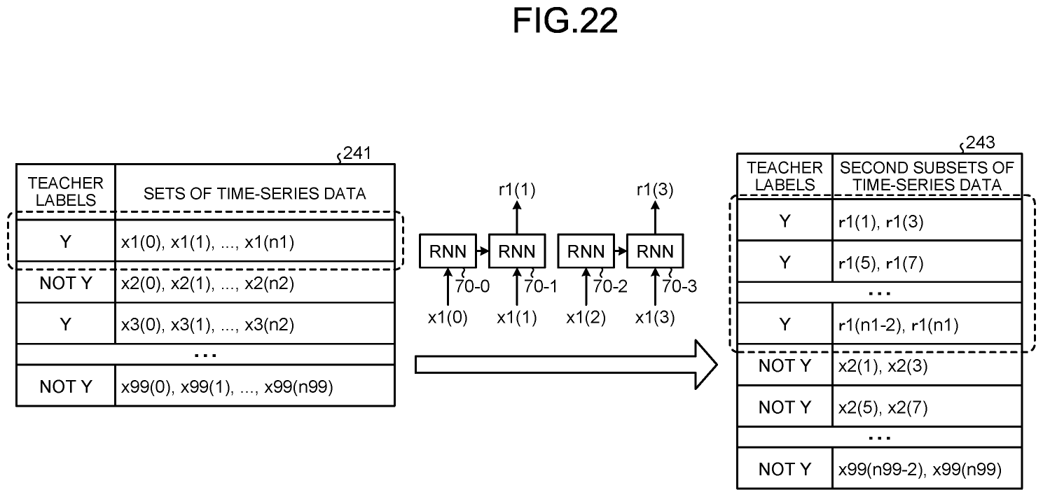

Description will now be made by reference to FIG. 15 again. The second generating unit 254 is a processing unit that generates, based on the learning data table 241, information for the second learning data table 243. FIG. 22 is a diagram illustrating processing by a second generating unit according to the second embodiment. The second generating unit 254 executes the RNN 70, and sets the parameter θ₇₀ learned by the first learning unit 253 for the RNN 70.

The second generating unit 254 divides time-series data in units of twos that are predetermined intervals of the RNN 70, and divides time-series of the GRU 71 into units of fours. The second generating unit 254 repeatedly executes a process of inputting the divided data respectively into the RNN 70-0 to RNN 70-3 and calculating hidden state vectors r output from the RNN 70-0 to RNN 70-3. The second generating unit 254 calculates plural second subsets of time-series data by dividing and inputting time-series data of one record in the learning data table 141. The teacher label corresponding to these plural second subsets of time-series data is the teacher label corresponding to the pre-division time-series data.

For example, by inputting the time-series data, “x1(0), x1(1), x1(2), and x1(3)”, to the RNN 70, the second generating unit 254 calculates a second subset of time-series data, “r1(0) and r1(3)”. A teacher label corresponding to that second subset of time-series data, “r1(0) and r1(3)”, is the teacher label, “Y”, of the time-series data, “x1(0), x1(1), . . . , x(n1)”.

The second generating unit 254 generates information for the second learning data table 243 by repeatedly executing the above described processing, for the other records in the learning data table 241. The second generating unit 254 stores the information for the second learning data table 243, into the second learning data table 243.

The second learning unit 255 is a processing unit that learns the parameter θ₇₁ of the GRU 71 of the hierarchical RNN, based on the second learning data table 243. The second learning unit 255 stores the learned parameter θ₇₁ into the parameter table 245.

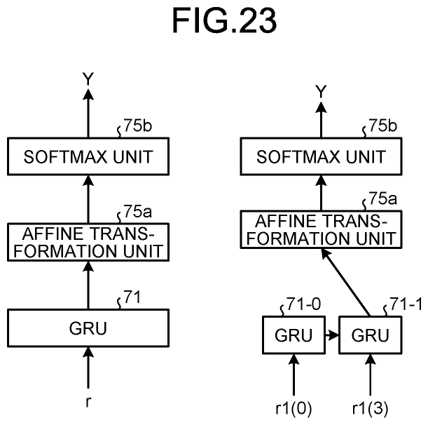

FIG. 23 is a diagram illustrating processing by a second learning unit according to the second embodiment. The second learning unit 255 executes the GRU 71, the affine transformation unit 75a, and the softmax unit 75b. The second learning unit 255 connects the GRU 71 to the affine transformation unit 75a, and connects the affine transformation unit 75a to the softmax unit 75b. The second learning unit 255 sets the parameter θ₇₁ of the GRU 71 to an initial value.

The second learning unit 255 sequentially inputs the second subsets of time-series data in the second learning data table 243 into the GRU 71-0 and GRU 71-1, and learns the parameter θ₇₁ of the GRU 71 and the parameter of the affine transformation unit 75a such that a deduced label output from the softmax unit 75b approaches the teacher label. The second learning unit 255 repeatedly executes the above described processing for the second subsets of time-series data stored in the second learning data table 243. For example, the second learning unit 255 learns the parameter θ₇₁ of the GRU 71 and the parameter of the affine transformation unit 75a, by using the gradient descent method or the like.

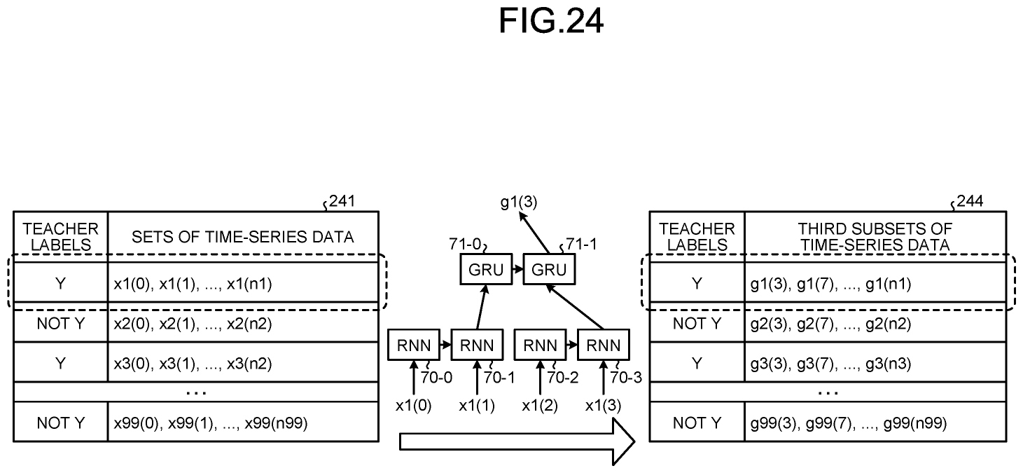

Description will now be made by reference to FIG. 15 again. The third generating unit 256 is a processing unit that generates, based on the learning data table 241, information for the third learning data table 244. FIG. 24 is a diagram illustrating processing by a third generating unit according to the second embodiment. The third generating unit 256 executes the RNN 70 and the GRU 71, and sets the parameter θ₇₀ that has been learned by the first learning unit 253, for the RNN 70. The third generating unit 256 sets the parameter θ₇₁ learned by the second learning unit 255, for the GRU 71.

The third generating unit 256 divides time-series data into units of fours. The third generating unit 256 repeatedly executes a process of inputting the divided data respectively into the RNN 70-0 to RNN 70-3 and calculating hidden state vectors g output from the GRU 71-1. By dividing and inputting time-series data of one record in the learning data table 241, the third generating unit 256 calculates a third subset of time-series data of that one record. A teacher label corresponding to that third subset of time-series data is the teacher label corresponding to the pre-division time-series data.

For example, by inputting the time-series data, “1(0), x1(1), x1(2), and x1(3)”, to the RNN 70, the third generating unit 256 calculates a third subset of time-series data, “g1(3)”. By inputting the time-series data, “x1(4), x1(5), x1(6), and x1(7)”, to the RNN 70, the third generating unit 256 calculates a third subset of time-series data “g1(7)”. By inputting the time-series data, “x1(n1-3), x1(n1-2), x1(n1-1), and x1(n1)”, to the RNN 70, the third generating unit 256 calculates a third subset of time-series data “g1(n1)”. A teacher label corresponding to these third subsets of time-series data “g1(3), g1(7), . . . , g1(n1)” is the teacher label, “Y”, of the time-series data, “x1(0), x1(1), . . . , x(n1)”.

The third generating unit 256 generates information for the third learning data table 244 by repeatedly executing the above described processing, for the other records in the learning data table 241. The third generating unit 256 stores the information for the third learning data table 244, into the third learning data table 244.

The third learning unit 257 is a processing unit that learns the parameter θ₇₂ of the LSTM 72 of the hierarchical RNN, based on the third learning data table 244. The third learning unit 257 stores the learned parameter θ₇₂ into the parameter table 245.

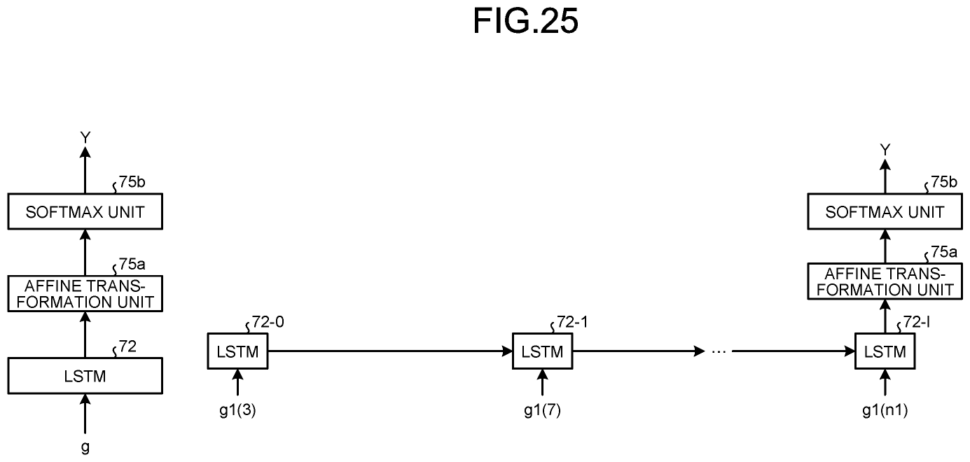

FIG. 25 is a diagram illustrating processing by a third learning unit according to the second embodiment. The third learning unit 257 executes the LSTM 72, the affine transformation unit 75a, and the softmax unit 75b. The third learning unit 257 connects the LSTM 72 to the affine transformation unit 75a, and connects the affine transformation unit 75a to the softmax unit 75b. The third learning unit 257 sets the parameter θ₇₂ of the LSTM 72 to an initial value.

The third learning unit 257 sequentially inputs the third subsets of time-series data in the third learning data table 244 into the LSTM 72, and learns the parameter θ₇₂ of the LSTM 72 and the parameter of the affine transformation unit 75a such that a deduced label output from the softmax unit 75b approaches the teacher label. The third learning unit 257 repeatedly executes the above described processing for the third subsets of time-series data stored in the third learning data table 244. For example, the third learning unit 257 learns the parameter θ₇₂ of the LSTM 72 and the parameter of the affine transformation unit 75a, by using the gradient descent method or the like.

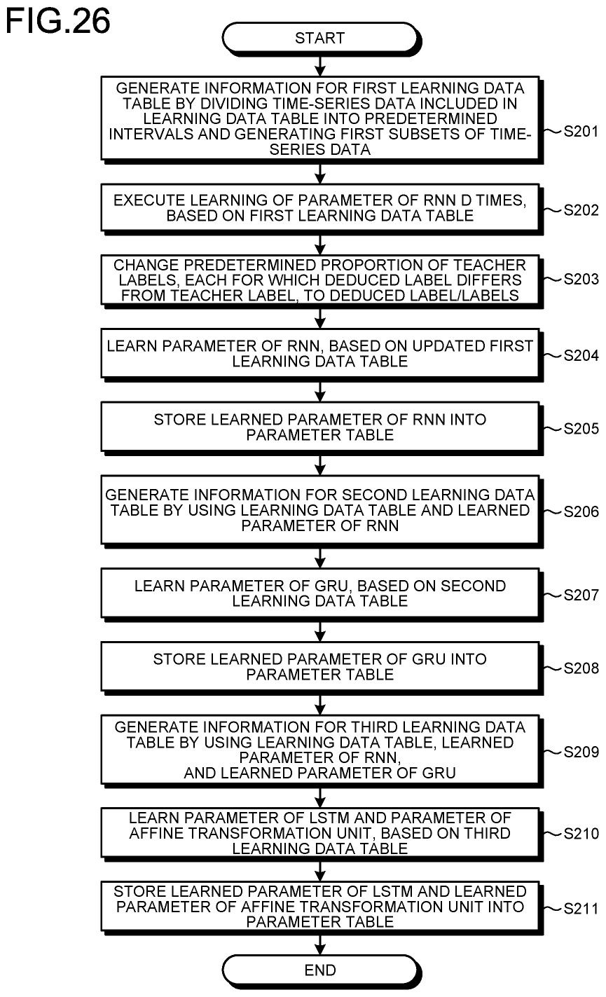

Described next is an example of a sequence of processing by the learning device 200 according to the second embodiment. FIG. 26 is a flow chart illustrating a sequence of processing by the learning device according to the second embodiment. As illustrated in FIG. 26, the first generating unit 252 of the learning device 200 generates first subsets of time-series data by dividing the time-series data included in the learning data table 241 into predetermined intervals, and thereby generates information for the first learning data table 242 (Step S201).

The first learning unit 253 of the learning device 200 executes learning of the parameter θ₇₀ of the RNN 70 for D times, based on the first learning data table 242 (Step S202). The first learning unit 253 changes a predetermined proportion of teacher labels, each for which the deduced label differs from the teacher label, to the deduced label/labels, for the first learning data table 242 (Step S203).

Based on the updated first learning data table 242, the first learning unit 253 learns the parameter θ₇₀ of the RNN 70 (Step S204). The first learning unit 253 may proceed to Step S205 after repeating the processing of Steps S203 and S204 for a predetermined number of times. The first learning unit 253 stores the learned parameter θ₇₀ of the RNN, into the parameter table 245 (Step S205).

The second generating unit 254 of the learning device 200 generates information for the second learning data table 243 by using the learning data table 241 and the learned parameter θ₇₀ of the RNN 70 (Step S206).

Based on the second learning data table 243, the second learning unit 255 of the learning device 200 learns the parameter θ₇₁ of the GRU 71 (Step S207). The second learning unit 255 stores the parameter θ₇₁ of the GRU 71, into the parameter table 245 (Step S208).

The third generating unit 256 of the learning device 200 generates information for the third learning data table 244, by using the learning data table 241, the learned parameter θ₇₀ of the RNN 70, and the learned parameter θ₇₁ of the GRU 71 (Step S209).

The third learning unit 257 learns the parameter θ₇₂ of the LSTM 72 and the parameter of the affine transformation unit 75a, based on the third learning data table 244 (Step S210). The third learning unit 257 stores the learned parameter θ₇₂ of the LSTM 72 and the learned parameter of the affine transformation unit 75a, into the parameter table 245 (Step S211). The information in the parameter table 245 may be reported to an external device, or may be output to and displayed on a terminal of an administrator.

Described next are effects of the learning device 200 according to the second embodiment. The learning device 200 generates the first learning data table 242 by dividing the time-series data in the learning data table 241 into predetermined intervals, and learns the parameter θ₇₀ of the RNN 70, based on the first learning data table 242. By using the learned parameter θ₇₀ and the data resulting from the division of the time-series data in the learning data table 241 into the predetermined intervals, the learning device 200 generates the second learning data table 243, and learns the parameter θ₇₁ of the GRU 71, based on the second learning data table 243. The learning device 200 generates the third learning data table 244 by using the learned parameters θ₇₀ and θ₇₁, and the data resulting from division of the time-series data in the learning data table 241 into the predetermined intervals, and learns the parameter θ₇₂ of the LSTM 72, based on the third learning data table 244. Accordingly, since the parameters θ₇₀, θ₇₁, and θ₇₂, of these layers are learned collectively in order, steady learning is enabled.

When the learning device 200 learns the parameter θ₇₀ of the RNN 70 based on the first learning data table 242, the learning device 200 compares the teacher labels with the deduced labels after performing learning D times. The learning device 200 updates a predetermined proportion of the teacher labels, each for which the deduced label differs from the teacher label, to the deduced label/labels. Execution of this processing prevents overlearning due to learning in short intervals.

The case where the learning device 200 according to the second embodiment inputs data in twos into the RNN 70 and GRU 71 has been described above, but the input of data is not limited to this case. For example, the data is preferably input: in eights to sixteens corresponding to word lengths, into the RNN 70; and in fives to tens corresponding to sentences, into the GRU 71.

### [c] Third Embodiment

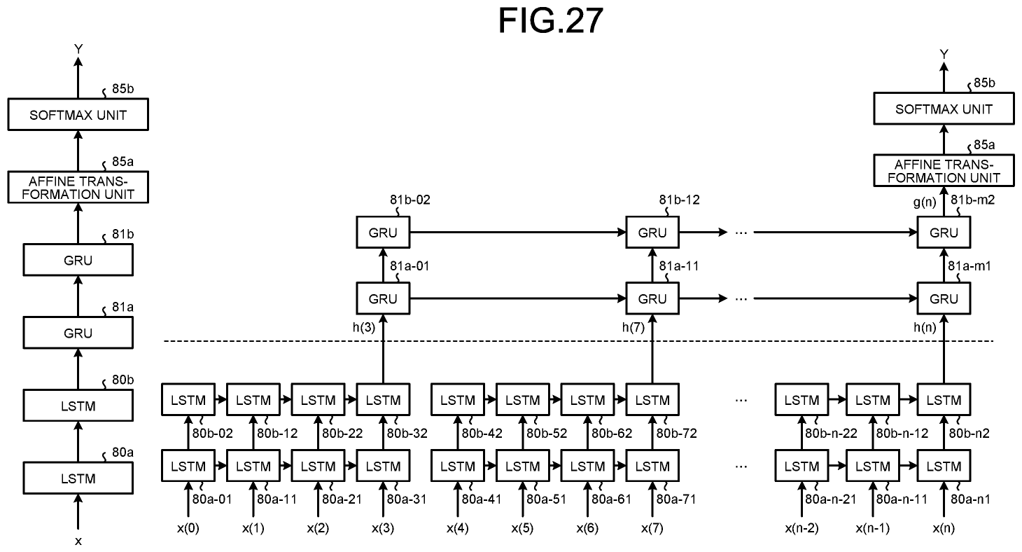

FIG. 27 is a diagram illustrating an example of a hierarchical RNN according to a third embodiment. As illustrated in FIG. 27, this hierarchical RNN has an LSTM 80a, an LSTM 80b, a GRU 81a, a GRU 81b, an affine transformation unit 85a, and a softmax unit 85b. FIG. 27 illustrates a case, as an example, where two LSTMs 80 are used as a lower layer LSTM, which is not limited to this example, and may have n LSTMs 80 arranged therein.

The LSTM 80a is connected to the LSTM 80b, and the LSTM 80b is connected to the GRU 81a. When data included in time-series data (for example, a word x) is input to the LSTM 80a, the LSTM 80a finds a hidden state vector by performing calculation based on a parameter θ₈₀ₐ of the LSTM 80a, and outputs the hidden state vector θ₈₀ₐ to the LSTM 80b. The LSTM 80a repeatedly executes the process of finding a hidden state vector by performing calculation based on the parameter θ₈₀ₐ by using next data and the hidden state vector that has been calculated from the previous data, when the next data is input to the LSTM 80a. The LSTM 80b finds a hidden state vector by performing calculation based on the hidden state vector input from the LSTM 80a and a parameter θ_{80b} of the LSTM 80b, and outputs the hidden state vector to the GRU 81a. For example, the LSTM 80b outputs a hidden state vector to the GRU 81a per input of four pieces of data.

For example, the LSTM 80a and LSTM 80b according to the third embodiment are each in fours in a time-series direction. The time-series data include data x(0), x(1), x(2), x(3), x(4), . . . , x(n).

When the data x(0) is input to the LSTM 80a-1, the LSTM 80a-01 finds a hidden state vector by performing calculation based on the data x(0) and the parameter θ₈₀ₐ, and outputs the hidden state vector to the LSTM 80b-02 and LSTM 80a-11. When the LSTM 80b-02 receives input of the hidden state vector, the LSTM 80b-02 finds a hidden state vector by performing calculation based on the parameter θ_{80b}, and outputs the hidden state vector to the LSTM 80b-12.

When the data x(1) and the hidden state vector are input to the LSTM 80a-11, the LSTM 80a-11 finds a hidden state vector by performing calculation based on the parameter θ₈₀ₐ, and outputs the hidden state vector to the LSTM 80b-12 and LSTM 80a-21. When the LSTM 80b-12 receives input of the two hidden state vectors, the LSTM 80b-12 finds a hidden state vector by performing calculation based on the parameter θ_{80b}, and outputs the hidden state vector to the LSTM 80b-22.

When the data x(2) and the hidden state vector are input to the LSTM 80a-21, the LSTM 80a-21 calculates a hidden state vector by performing calculation based on the parameter θ₈₀ₐ, and outputs the hidden state vector to the LSTM 80b-22 and LSTM 80a-31. When the LSTM 80b-22 receives input of the two hidden state vectors, the LSTM 80b-22 finds a hidden state vector by performing calculation based on the parameter θ_{80b}, and outputs the hidden state vector to the LSTM 80b-32.

When the data x(3) and the hidden state vector are input to the LSTM 80a-31, the LSTM 80a-31 calculates a hidden state vector by performing calculation based on the parameter θ₈₀ₐ, and outputs the hidden state vector to the LSTM 80b-32. When the LSTM 80b-32 receives input of the two hidden state vectors, the LSTM 80b-32 finds a hidden state vector h(3) by performing calculation based on the parameter θ_{80b}, and outputs the hidden state vector h(3) to the GRU 81a-01.

When the data x(4) to x(7) are input to the LSTM 80a-41 to 80a-71 and LSTM 80b-42 to 80b-72, similarly to the LSTM 80a-01 to 80a-31 and LSTM 80b-02 to 80b-32, the LSTM 80a-41 to 80a-71 and LSTM 80b-42 to 80b-72 calculate hidden state vectors. The LSTM 80b-72 outputs the hidden state vector h(7) to the GRU 81a-11.

When the data x(n−2) to x(n) are input to the LSTM 80a-n-21 to 80a-n1 and the LSTM 80b-n-22 to 80b-n2, similarly to the LSTM 80a-01 to 80a-31 and LSTM 80b-02 to 80b-32, the LSTM 80a-n21 to 80a-n1 and the LSTM 80b-n-22 to 80b-n2 calculate hidden state vectors. The LSTM 80b-n2 outputs a hidden state vector h(n) to the GRU 81a-m1.

The GRU 81a is connected to the GRU 81b, and the GRU 81b is connected to the affine transformation unit 85a. When a hidden state vector is input to the GRU 81a from the LSTM 80b, the GRU 81a finds a hidden state vector by performing calculation based on a parameter θ₈₁ₐ of the GRU 81a, and outputs the hidden state vector θ₈₁ₐ to the GRU 81b. When the hidden state vector is input to the GRU 81b from the GRU 81a, the GRU 81b finds a hidden state vector by performing calculation based on a parameter θ_{81b} of the GRU 81b, and outputs the hidden state vector to the affine transformation unit 85a. The GRU 81a and GRU 81b repeatedly execute the above described processing.

When the hidden state vector h(3) is input to the GRU 81a-01, the GRU 81a-01 finds a hidden state vector by performing calculation based on the hidden state vector h(3) and the parameter θ₈₁ₐ, and outputs the hidden state vector to the GRU 81b-02 and GRU 81a-11. When the GRU 81b-02 receives input of the hidden state vector, the GRU 81b-02 finds a hidden state vector by performing calculation based on the parameter θ_{81b}, and outputs the hidden state vector to the GRU 81b-12.

When the hidden state vector h(7) and the hidden state vector of the previous GRU are input to the GRU 81a-11, the GRU 81a-11 finds a hidden state vector by performing calculation based on the parameter θ₈₁ₐ, and outputs the hidden state vector to the GRU 81b-12 and GRU 81a-31 (not illustrated in the drawings). When the GRU 81b-12 receives input of the two hidden state vectors, the GRU 81b-12 finds a hidden state vector by performing calculation based on the parameter θ_{81b}, and outputs the hidden state vector to the GRU 81b-22 (not illustrated in the drawings).

When the hidden state vector h(n) and the hidden state vector of the previous GRU are input to the GRU 81a-m1, the GRU 81a-m1 finds a hidden state vector by performing calculation based on the parameter θ₈₁ₐ, and outputs the hidden state vector to the GRU 81b-m2. When the GRU 81b-m2 receives input of the two hidden state vectors, the GRU 81b-m2 finds a hidden state vector g(n) by performing calculation based on the parameter θ_{81b}, and outputs the hidden state vector g(n) to the affine transformation unit 85a.

The affine transformation unit 85a is a processing unit that executes affine transformation on the hidden state vector g(n) output from the GRU 81b. For example, based on Equation (3), the affine transformation unit 85a calculates a vector Y_{A} by executing affine transformation. Description related to “A” and “b” included in Equation (3) is the same as the description related to “A” and “b” included in Equation (1).

Y_{A}=Ag(n)+b (3)

The softmax unit 85b is a processing unit that calculates a value, “Y”, by inputting the vector Y_{A} resulting from the affine transformation, into a softmax function. This “Y” is a vector that is a result of estimation for the time-series data.

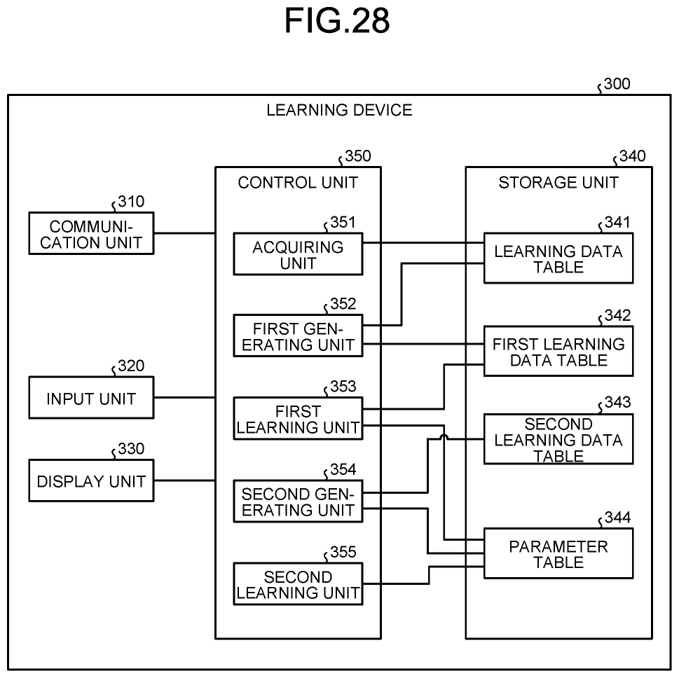

Described next is an example of a configuration of a learning device according to the third embodiment. FIG. 28 is a functional block diagram illustrating the configuration of the learning device according to the third embodiment. As illustrated in FIG. 28, this learning device 300 has a communication unit 310, an input unit 320, a display unit 330, a storage unit 340, and a control unit 350.

The communication unit 310 is a processing unit that executes communication with an external device (not illustrated in the drawings) via a network or the like. For example, the communication unit 310 receives information for a learning data table 341 described later, from the external device. The communication unit 210 is an example of a communication device. The control unit 350 described later exchanges data with the external device via the communication unit 310.

The input unit 320 is an input device for input of various types of information into the learning device 300. For example, the input unit 320 corresponds to a keyboard, or a touch panel.

The display unit 330 is a display device that displays thereon various types of information output from the control unit 350. The display unit 330 corresponds to a liquid crystal display, a touch panel, or the like.

The storage unit 340 has the learning data table 341, a first learning data table 342, a second learning data table 343, and a parameter table 344. The storage unit 340 corresponds to: a semiconductor memory device, such as a RAM, a ROM, or a flash memory; or a storage device, such as an HDD.

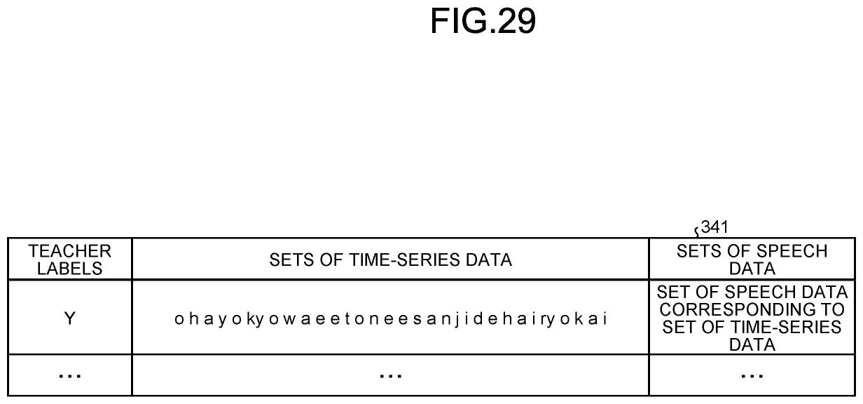

The learning data table 341 is a table storing therein learning data. FIG. 29 is a diagram illustrating an example of a data structure of a learning data table according to the third embodiment. As illustrated in FIG. 29, the learning data table 341 has therein teacher labels, sets of time-series data, and sets of speech data, in association with one another. The sets of time-series data according to the third embodiment are sets of phoneme string data related to speech of a user or users. The sets of speech data are sets of speech data, from which the sets of time-series data are generated.

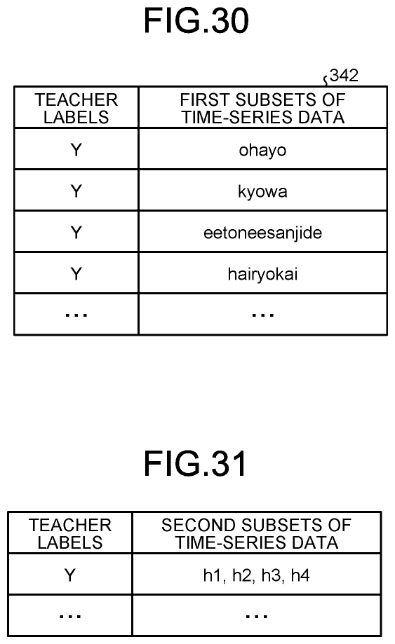

The first learning data table 342 is a table storing therein first subsets of time-series data resulting from division of the sets of time-series data stored in the learning data table 341. According to this third embodiment, the time-series data are divided according to predetermined references, such as breaks in speech or speaker changes. FIG. 30 is a diagram illustrating an example of a data structure of a first learning data table according to the third embodiment. As illustrated in FIG. 30, the first learning data table 342 has therein teacher labels associated with the first subsets of time-series data. Each of the first subsets of time-series data is data resulting from division of a set of time-series data according to predetermined references.

The second learning data table 343 is a table storing therein second subsets of time-series data acquired by input of the first subsets of time-series data in the first learning data table 342 into the LSTM 80a and LSTM 80b. FIG. 31 is a diagram illustrating an example of a data structure of a second learning data table according to the third embodiment. As illustrated in FIG. 31, the second learning data table 343 has therein teacher labels associated with the second subsets of time-series data. Each of the second subsets of time-series data is acquired by input of the first subsets of time-series data in the first learning data table 142 into the LSTM 80a and LSTM 80b.

The parameter table 344 is a table storing therein the parameter θ₈₀ₐ of the LSTM 80a, the parameter θ_{80b} of the LSTM 80b, the parameter θ₈₁ₐ of the GRU 81a, the parameter θ_{81b} of the GRU 81b, and the parameter of the affine transformation unit 85a.

The control unit 350 is a processing unit that learns a parameter by executing the hierarchical RNN illustrated in FIG. 27. The control unit 350 has an acquiring unit 351, a first generating unit 352, a first learning unit 353, a second generating unit 354, and a second learning unit 355. The control unit 350 may be realized by a CPU, an MPU, or the like. Furthermore, the control unit 350 may be realized by hard wired logic, such as an ASIC or an FPGA.

The acquiring unit 351 is a processing unit that acquires information for the learning data table 341 from an external device (not illustrated in the drawings) via a network. The acquiring unit 351 stores the acquired information for the learning data table 341, into the learning data table 341.

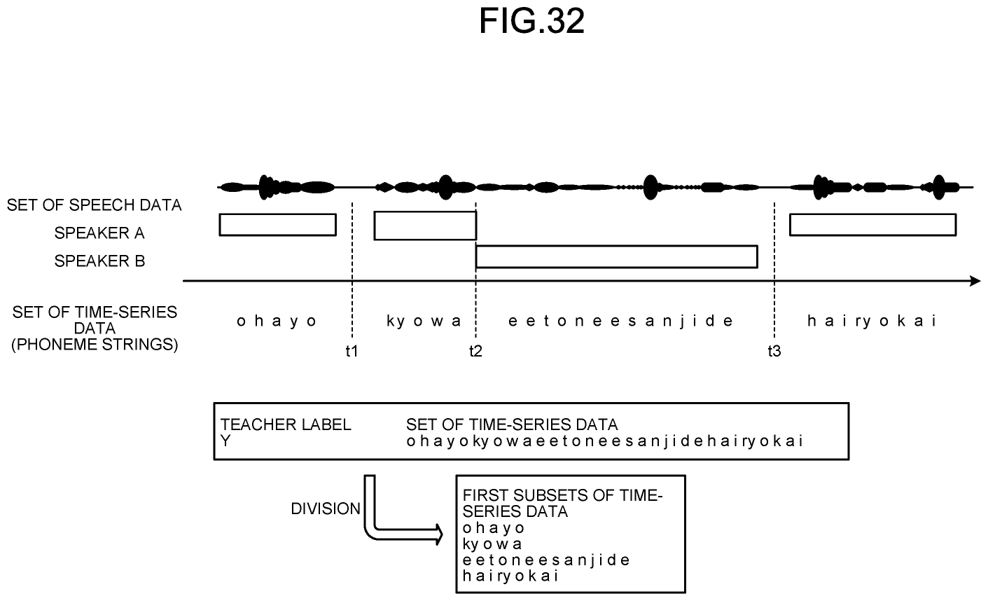

The first generating unit 352 is a processing unit that generates information for the first learning data table 342, based on the learning data table 341. FIG. 32 is a diagram illustrating processing by a first generating unit according to the third embodiment. The first generating unit 352 selects a set of time-series data from the learning data table 341. For example, the set of time-series data is associated with speech data of a speaker A and a speaker B. The first generating unit 352 calculates feature values of speech corresponding to the set of time-series data, and determines, for example, speech break times where speech power becomes less than a threshold. In an example illustrated in FIG. 32, the speech break times are t1, t2, and t3.

The first generating unit 352 divides the set of time-series data into plural first subsets of time-series data, based on the speech break times t1, t2, and t3. In the example illustrated in FIG. 32, the first generating unit 352 divides a set of time-series data, “ohayokyowaeetoneesanjidehairyokai”, into first subsets of time-series data, “ohayo”, “kyowa”, “eetoneesanjide”, and “hairyokai”. The first generating unit 352 stores a teacher label, “Y”, corresponding to the set of time-series data, in association with each of the first subsets of time-series data, into the first learning data table 342.

The first learning unit 353 is a processing unit that learns the parameter θ₈₀ of the LSTM 80, based on the first learning data table 342. The first learning unit 353 stores the learned parameter θ₈₀ into the parameter table 344.

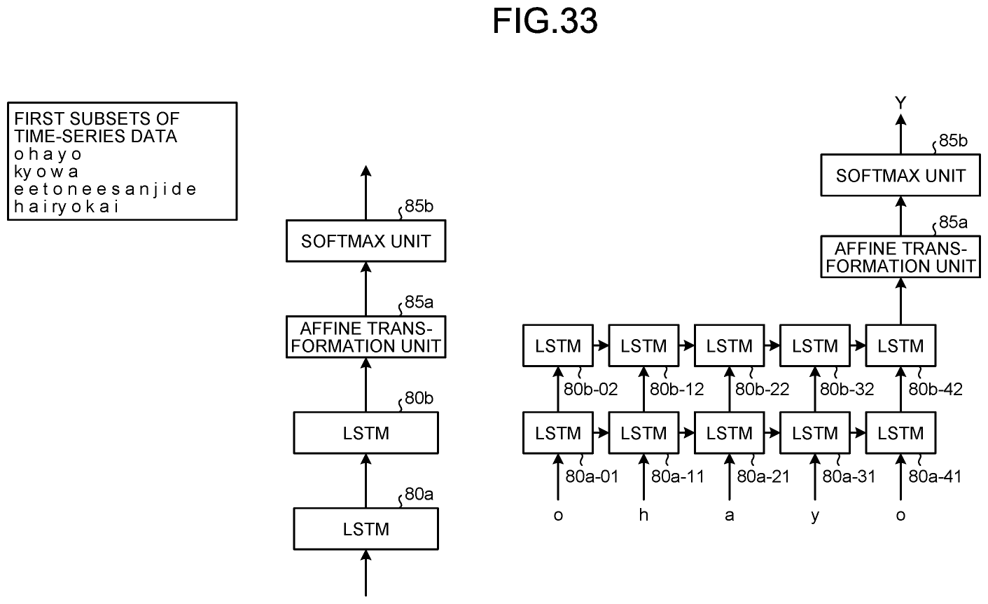

FIG. 33 is a diagram illustrating processing by a first learning unit according to the third embodiment. The first learning unit 353 executes the LSTM 80a, the LSTM 80b, the affine transformation unit 85a, and the softmax unit 85b. The first learning unit 353 connects the LSTM 80a to the LSTM 80b, connects the LSTM 80b to the affine transformation unit 85a, and connects the affine transformation unit 85a to the softmax unit 85b. The first learning unit 353 sets the parameter θ₈₀ₐ of the LSTM 80a to an initial value, and sets the parameter θ_{80b} of the LSTM 80b to an initial value.

The first learning unit 353 sequentially inputs the first subsets of time-series data stored in the first learning data table 342 into the LSTM 80a and LSTM 80b, and learns the parameter θ₈₀ₐ of the LSTM 80a, the parameter θ_{80b} of the LSTM 80b, and the parameter of the affine transformation unit 85a. The first learning unit 353 repeatedly executes the above described processing “D” times for the first subsets of time-series data stored in the first learning data table 342. This “D” is a value that is set beforehand, and for example, “D=10”. The first learning unit 353 learns the parameter θ₈₀ₐ of the LSTM 80a, the parameter θ_{80b} of the LSTM 80b, and the parameter of the affine transformation unit 85a, by using the gradient descent method or the like.

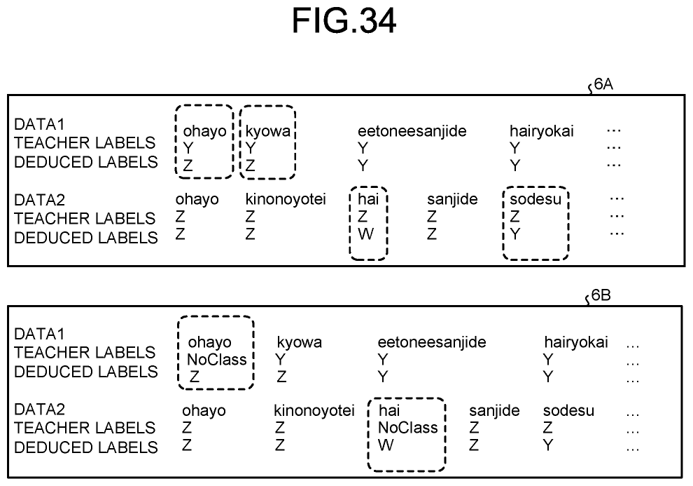

When the first learning unit 353 has performed the learning “D” times, the first learning unit 353 executes a process of updating the teacher labels in the first learning data table 342. FIG. 34 is a diagram illustrating an example of a teacher label updating process by the first learning unit according to the third embodiment.

A learning result 6A in FIG. 34 has the first subsets of time-series data (data 1, data 2, . . . ), teacher labels, and deduced labels, in association with one another. For example, “ohayo” of the data 1 indicates that a string of phonemes, “o”, “h”, “a”, “y”, and “o”, has been input to the LSTM 80. The teacher labels are teacher labels defined in the first learning data table 342 and corresponding to the first subsets of time-series data. The deduced labels are deduced labels output from the softmax unit 85b when the first subsets of time-series data are input to the LSTM 80 in FIG. 33. In the learning result 6A, a teacher label for “ohayo” of the data 1 is “Y”, and a deduced label thereof is “Z”.

In the example represented by the learning result 6A, teacher labels for “ohayo” of the data 1, “kyowa” of the data 1, “hai” of the data 2, and “sodesu” of the data 2, are different from their deduced labels. The first learning unit 353 updates a predetermined proportion of the teacher labels, each for which the deduced label differs from the teacher label, to the deduced label/labels, and/or another label or other labels other than the deduced label/labels (for example, to a label indicating that the data is uncategorized). As represented by an update result 6B, the first learning unit 353 updates the teacher label corresponding to “ohayo” of the data 1 to “No Class”, and the teacher label corresponding to “hai” of the data 1 to “No Class”. The first learning unit 353 causes the update described by reference to FIG. 34 to be reflected in the teacher labels in the first learning data table 342.

By using the updated first learning data table 342, the first learning unit 353 learns the parameter θ₈₀ of the LSTM 80 and the parameter of the affine transformation unit 85a, again. The first learning unit 353 stores the learned parameter θ₈₀ of the LSTM 80 into the parameter table 344.

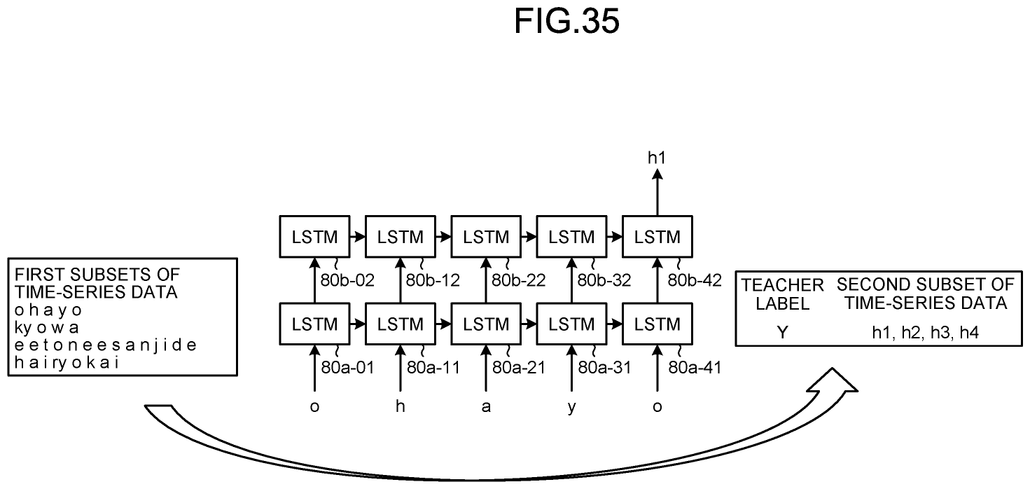

Description will now be made by reference to FIG. 28 again. The second generating unit 354 is a processing unit that generates information for the second learning data table 343, based on the first learning data table 342. FIG. 35 is a diagram illustrating processing by a second generating unit according to the third embodiment.

The second generating unit 354 executes the LSTM 80a and LSTM 80b, sets the parameter θ₈₀ₐ that has been learned by the first learning unit 353 for the LSTM 80a, and sets the parameter θ_{80b} for the LSTM 80b. The second generating unit 354 repeatedly executes a process of calculating a hidden state vector h by sequentially inputting the first subsets of time-series data into the LSTM 80a-01 to 80a-41. The second generating unit 354 calculates a second subset of time-series data by inputting the first subsets of time-series data resulting from division of time-series data of one record in the learning data table 341 into the LSTM 80a. A teacher label corresponding to that second subset of time-series data is the teacher label corresponding to the pre-division time-series data.

For example, by inputting the first subsets of time-series data, “ohayo”, “kyowa”, “eetoneesanjide”, and “hairyokai”, respectively into the LSTM 80a, the second generating unit 354 calculates a second subset of time-series data, “h1, h2, h3, and h4”. A teacher label corresponding to the second subset of time-series data, “h1, h2, h3, and h4” is the teacher label, “Y”, for the time-series data, “ohayokyowaeetoneesanjidehairyokai”.

The second generating unit 354 generates information for the second learning data table 343 by repeatedly executing the above described processing for the other records in the first learning data table 342. The second generating unit 354 stores the information for the second learning data table 343, into the second learning data table 343.

The second learning unit 355 is a processing unit that learns the parameter θ₈₁ₐ of the GRU 81a of the hierarchical RNN and the parameter θ_{81b} of the GRU 81b of the hierarchical RNN, based on the second learning data table 343. The second learning unit 355 stores the learned parameters θ₈₁ₐ and θ_{81b} into the parameter table 344. Furthermore, the second learning unit 355 stores the parameter of the affine transformation unit 85a into the parameter table 344.

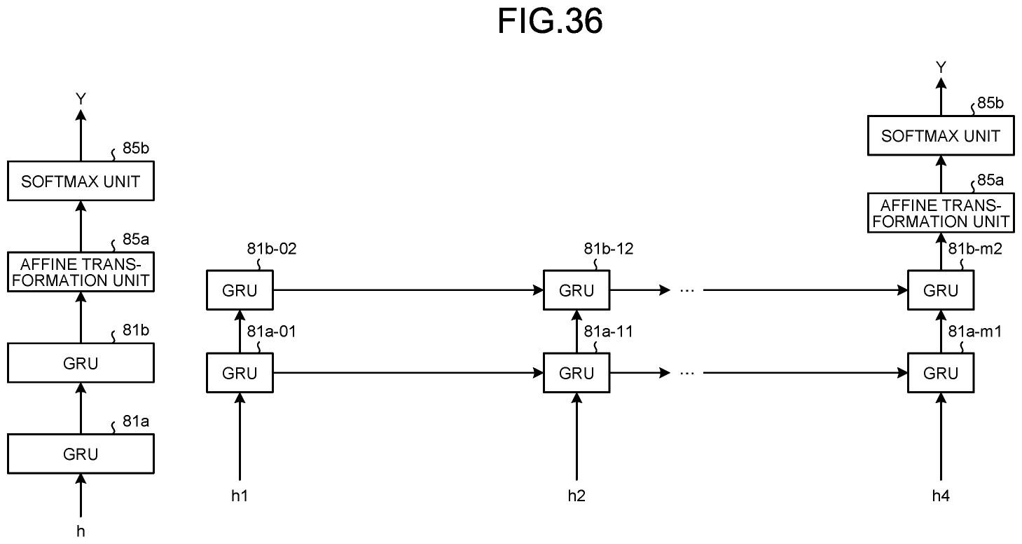

FIG. 36 is a diagram illustrating processing by a second learning unit according to the third embodiment. The second learning unit 355 executes the GRU 81a, the GRU 81b, the affine transformation unit 85a, and the softmax unit 85b. The second learning unit 355 connects the GRU 81a to the GRU 81b, connects the GRU 81b to the affine transformation unit 85a, and connects the affine transformation unit 85a to the softmax unit 85b. The second learning unit 355 sets the parameter θ₈₁ₐ of the GRU 81a to an initial value, and sets the parameter θ_{81b} of the GRU 81b to an initial value.

The second learning unit 355 sequentially inputs the second subsets of time-series data in the second learning data table 343 into the GRU 81, and learns the parameters θ₈₁ₐ and θ_{81b} of the GRU 81a and GRU 81b and the parameter of the affine transformation unit 85a such that a deduced label output from the softmax unit 85b approaches the teacher label. The second learning unit 355 repeatedly executes the above described processing for the second subsets of time-series data stored in the second learning data table 343. For example, the second learning unit 355 learns the parameters θ₈₁ₐ and θ_{81b} of the GRU 81a and GRU 81b and the parameter of the affine transformation unit 85a, by using the gradient descent method or the like.

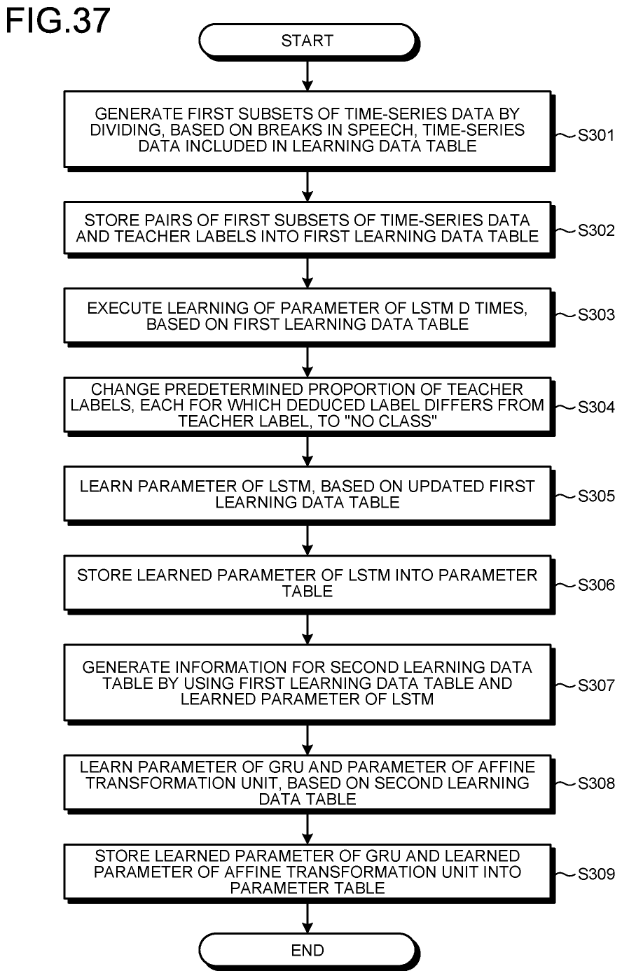

Described next is an example of a sequence of processing by the learning device 300 according to the third embodiment. FIG. 37 is a flow chart illustrating a sequence of processing by the learning device according to the third embodiment. In the following description, the LSTM 80a and LSTM 80a will be collectively denoted as the LSTM 80, as appropriate. The parameter θ₈₀ₐ and parameter θ_{80b} will be collectively denoted as the parameter θ₈₀. The GRU 81a and GRU 81b will be collectively denoted as the GRU 81. The parameter θ₈₁ₐ and parameter θ_{81b} will be collectively denoted as the parameter θ₈₁. As illustrated in FIG. 37, the first generating unit 352 of the learning device 300 generates first subsets of time-series data by dividing, based on breaks in speech, the time-series data included in the learning data table 341 (Step S301). The first generating unit 352 stores pairs of the first subsets of time-series data and teacher labels, into the first learning data table 242 (Step S302).

The first learning unit 353 of the learning device 300 executes learning of the parameter θ₈₀ of the LSTM 80 for D times, based on the first learning data table 242 (Step S303). The first learning unit 353 changes a predetermined proportion of teacher labels, each for which the deduced label differs from the teacher label, to “No Class”, for the first learning data table 342 (Step S304).

Based on the updated first learning data table 342, the first learning unit 353 learns the parameter θ₈₀ of the LSTM 80 (Step S305). The first learning unit 353 stores the learned parameter θ₈₀ of the LSTM 80, into the parameter table 344 (Step S306).

The second generating unit 354 of the learning device 300 generates information for the second learning data table 343 by using the first learning data table 342 and the learned parameter θ₈₀ of the LSTM 80 (Step S307).

Based on the second learning data table 343, the second learning unit 355 of the learning device 300 learns the parameter θ₈₁ of the GRU 81 and the parameter of the affine transformation unit 85a (Step S308). The second learning unit 255 stores the parameter θ₈₁ of the GRU 81 and the parameter of the affine transformation unit 85a, into the parameter table 344 (Step S309).

Described next are effects of the learning device 300 according to the third embodiment. The learning device 300 calculates feature values of speech corresponding to time-series data, and determines, for example, speech break times where speech power becomes less than a threshold, and generates, based on the determined break times, first subsets of time-series data. Learning of the LSTM 80 and GRU 81 is thereby enabled in units of speech intervals.

The learning device 300 compares teacher labels with deduced labels after performing learning D times when learning the parameter θ₈₀ of the LSTM 80 based on the first learning data table 342. The learning device 300 updates a predetermined proportion of the teacher labels, each for which the deduced label differs from the teacher label, to a label indicating that the data are uncategorized. By executing this processing, influence of intervals of phoneme strings not contributing to the overall identification is able to be eliminated.

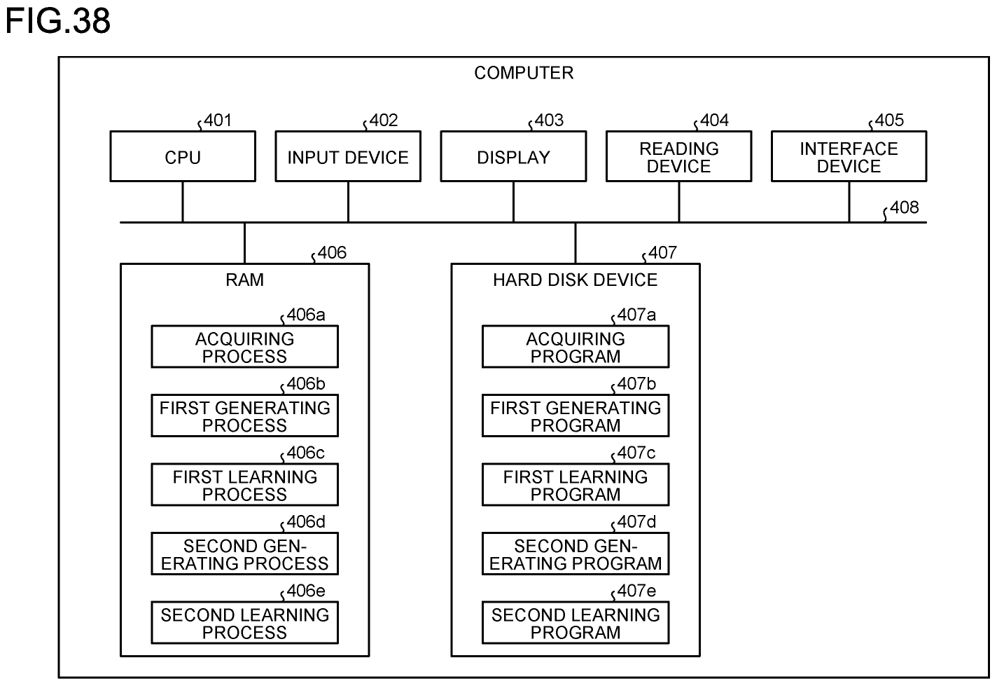

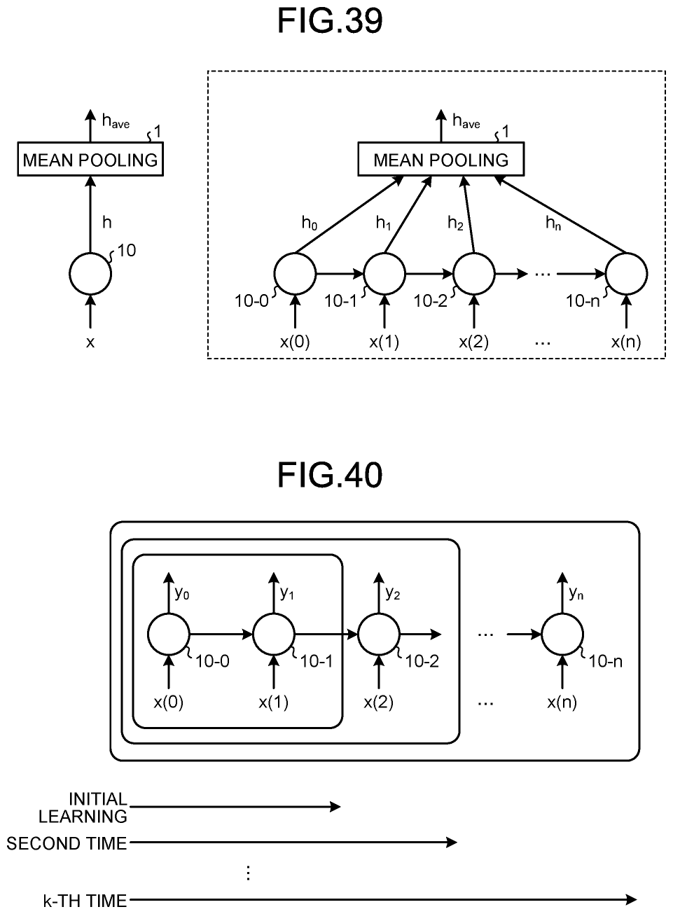

Described next is an example of a hardware configuration of a computer that realizes functions that are the same as those of any one of the learning devices 100, 200, and 300 according to the embodiments. FIG. 38 is a diagram illustrating an example of a hardware configuration of a computer that realizes functions that are the same as those of a learning device according to any one of the embodiments.

As illustrated in FIG. 38, a computer 400 has: a CPU 401 that executes various types of arithmetic processing; an input device 402 that receives input of data from a user; and a display 403. Furthermore, the computer 400 has: a reading device 404 that reads a program or the like from a storage medium; and an interface device 405 that transfers data to and from an external device or the like via a wired or wireless network. The computer 400 has: a RAM 406 that temporarily stores therein various types of information; and a hard disk device 407. Each of these devices 401 to 407 is connected to a bus 408.

The hard disk device 407 has an acquiring program 407a, a first generating program 407b, a first learning program 407c, a second generating program 407d, and a second learning program 407e. The CPU 401 reads the acquiring program 407a, the first generating program 407b, the first learning program 407c, the second generating program 407d, and the second learning program 407e, and loads these programs into the RAM 406.

The acquiring program 407a functions as an acquiring process 406a. The first generating program 407b functions as a first generating process 406b. The first learning program 407c functions as a first learning process 406c. The second generating program 407d functions as a second generating process 406d. The second learning program 407e functions as a second learning process 406e.

Processing in the acquiring process 406a corresponds to the processing by the acquiring unit 151, 251, or 351. Processing in the first generating process 406b corresponds to the processing by the first generating unit 152, 252, or 352. Processing in the first learning process 406c corresponds to the processing by the first learning unit 153, 253, or 353. Processing in the second generating process 406d corresponds to the processing by the second generating unit 154, 254, or 354. Processing in the second learning process 406e corresponds to the processing by the second learning unit 155, 255, or 355.

Each of these programs 407a to 407e is not necessarily stored initially in the hard disk device 407 beforehand. For example, each of these programs 407a to 407e may be stored in a “portable physical medium”, such as a flexible disk (FD), a CD-ROM, a DVD, a magneto-optical disk, or an IC card, which is inserted into the computer 400. The computer 400 then may read and execute each of these programs 407a to 407e.

The hard disk device 407 may have a third generating program and a third learning program, although illustration thereof in the drawings has been omitted. The CPU 401 reads the third generating program and the third learning program, and loads these programs into the RAM 406. The third generating program and the third learning program function as a third generating process and a third learning process. The third generating process corresponds to the processing by the third generating unit 256. The third learning process corresponds to the processing by the third learning unit 257.

Steady learning is able to be performed efficiently in a short time.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A learning device comprising:
a memory; and
a processor coupled to the memory and configured to:
generate plural first subsets of time-series data by dividing time-series data into predetermined intervals, the time-series data including plural sets of data arranged in time series, and generate first learning data including each of the plural first subsets of time-series data associated with teacher data corresponding to the whole time-series data;
learn, based on the first learning data, a first parameter of a first RNN of recurrent neural networks (RNNs), included in plural layers, the first RNN being included in a first layer; and
set the learned first parameter for the first RNN, and learn, based on data and the teacher data, parameters of the RNNs included in the plural layers, the data being acquired by input of each of the first subsets of time-series data into the first RNN, in a case where the parameters of the RNNs included in the plural layers are learned.

2. The learning device according to claim 1, wherein the processor is further configured to:
set the learned first parameter for the first RNN;
generate second learning data including each of plural second subsets of time-series data associated with the teacher data, the plural second subsets of time-series data being acquired by input of each of the first subsets of time-series data into the first RNN; and
learn, based on the second learning data, a second parameter of a second RNN included in a second layer that is one layer higher than the first layer.

3. The learning device according to claim 1, wherein the processor is further configured to: in a case where output data output when the first subsets of time-series data are input to the first RNN is different from the teacher data, generate the first learning data, by updating the teacher data to the output data, the teacher data corresponding to the first subsets of time-series data, for a part of plural pairs of the first subsets of time-series data and the teacher data, the plural pairs being included in the first learning data.

4. The learning device according to claim 1, wherein the processor is further configured to: in a case where output data output when the first subsets of time-series data are input to the first RNN is different from the teacher data, generate the first learning data, by updating the teacher data to other data that is different from the teacher data and output data, the teacher data corresponding to the first subsets of time-series data, for a part of plural pairs of the first subsets of time-series data and the teacher data, the plural pairs being included in the first learning data.

5. The learning device according to claim 1, wherein the processor is further configured to: divide, based on features of speech data corresponding to the time-series data, the time-series data into the plural first subsets of time-series data.

6. A learning method comprising:
generating, by a processor, plural first subsets of time-series data by dividing time-series data into predetermined intervals, the time-series data including plural sets of data arranged in time series, and generating first learning data including each of the plural first subsets of time-series data associated with teacher data corresponding to the whole time-series data;
learning, based on the first learning data, a first parameter of a first RNN of recurrent neural networks (RNNs), included in plural layers, the first RNN being included in a first layer; and
setting the learned first parameter for the first RNN, and learning, based on data and the teacher data, parameters of the RNNs included in the plural layers, the data being acquired by input of each of the first subsets of time-series data into the first RNN, in a case where the parameters of the RNNs included in the plural layers are learned.

7. The learning method according to claim 6, wherein the learning of the parameters of the RNNs included in the plural layers includes: setting the learned first parameter for the first RNN; generating second learning data including each of plural second subsets of time-series data associated with the teacher data, the plural second subsets of time-series data being acquired by input of each of the first subsets of time-series data into the first RNN; and learning, based on the second learning data, a second parameter of a second RNN included in a second layer that is one layer higher than the first layer.

8. The learning method according to claim 6, wherein the generating the first learning data includes: in a case where output data output when the first subsets of time-series data are input to the first RNN is different from the teacher data, generating the first learning data, by updating the teacher data to the output data, the teacher data corresponding to the first subsets of time-series data, for a part of plural pairs of the first subsets of time-series data and the teacher data, the plural pairs being included in the first learning data.

9. The learning method according to claim 6, wherein the generating the first learning data includes: in a case where output data output when the first subsets of time-series data are input to the first RNN is different from the teacher data, generating the first learning data, by updating the teacher data to other data different from the teacher data and output data, the teacher data corresponding to the first subsets of time-series data, for a part of plural pairs of the first subsets of time-series data and the teacher data, the plural pairs being included in the first learning data.

10. The learning method according to claim 6, wherein the generating the first learning data includes dividing, based on features of speech data corresponding to the time-series data, the time-series data into the plural first subsets of time-series data.

11. A non-transitory computer-readable recording medium storing therein a learning program that causes a computer to execute a process comprising:
generating plural first subsets of time-series data by dividing time-series data into predetermined intervals, the time-series data including plural sets of data arranged in time series, and generating first learning data including each of the plural first subsets of time-series data associated with teacher data corresponding to the whole time-series data;
learning, based on the first learning data, a first parameter of a first RNN of recurrent neural networks (RNNs), included in plural layers, the first RNN being included in a first layer; and
setting the learned first parameter for the first RNN, and learning, based on data and the teacher data, parameters of the RNNs included in the plural layers, the data being acquired by input of each of the first subsets of time-series data into the first RNN, in a case where the parameters of the RNNs included in the plural layers are learned.

12. The non-transitory computer-readable recording medium according to claim 11, wherein the learning parameters of the RNNs included in the plural layers includes: setting the learned first parameter for the first RNN; generating second learning data including each of plural second subsets of time-series data associated with the teacher data, the plural second subsets of time-series data being acquired by input of each of the first subsets of time-series data into the first RNN; and learning, based on the second learning data, a second parameter of a second RNN included in a second layer that is one layer higher than the first layer.

13. The non-transitory computer-readable recording medium according to claim 11, wherein the generating the first learning data includes: in a case where output data output when the first subsets of time-series data are input to the first RNN is different from the teacher data, generating the first learning data, by updating the teacher data to the output data, the teacher data corresponding to the first subsets of time-series data, for a part of plural pairs of the first subsets of time-series data and the teacher data, the plural pairs being included in the first learning data.

14. The non-transitory computer-readable recording medium according to claim 11, wherein the generating the first learning data includes: in a case where output data output when the first subsets of time-series data are input to the first RNN is different from the teacher data, generating the first learning data, by updating the teacher data to other data different from the teacher data and output data, the teacher data corresponding to the first subsets of time-series data, for a part of plural pairs of the first subsets of time-series data and the teacher data, the plural pairs being included in the first learning data.

15. The non-transitory computer-readable recording medium according to claim 11, wherein the generating the first learning data includes dividing, based on features of speech data corresponding to the time-series data, the time-series data into the plural first subsets of time-series data.
